(19) United States
(12) Patent Application Publication
(10) Pub. No.: US 2004/0078225 A1
(43) Pub. Date: Apr. 22, 2004

(54) Computer assisted and/or implemented process and system for managing and/or providing continuing healthcare education status and activities

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: HALE & DORR LLP, THE WILLARD OFFICE BUILDING, 1455 PENNSYLVANIA AVE, NW, WASHINGTON, DC, 20004, US

(73) Assignee: Merck & Co., Inc., Rahway, NJ

(21) Appl. No.: 10/390,539

(22) Filed: Mar. 18, 2003

Related U.S. Application Data
(60) Provisional application No. 60/364,743, filed on Mar. 18, 2002.

(51) Int. Cl. G06F 17/60

(52) U.S. Cl. 705/2

(57) ABSTRACT

The invention provides a method, system, and computer program device for an interactive continuing education system, for managing and/or providing continuing education activities, especially useful for healthcare professionals. The invention may provide a personal profile, to provide a snapshot of the user's CE activities vis-à-vis CE requirements; a curriculum manager, to provide details on CE activities in a user's curriculum; a catalog browser, for reviewing/searching a catalog of available CE activities; a transcript manager for tracking completed activities and providing customizable transcripts; a showcase of selected CE activities; and a CE assistant feature, for notifying a user of new CE activities which fit the user's preference. The system accommodates a catalog of available CE activities, and enable a user to easily launch and automatically track CE activities. Each user has a curriculum of on-going CE activities, and a transcript of completed CE activities. By grouping and inter-connecting various features, the user may interactively and conveniently track, organize, and manage their healthcare education portfolio.

### RELATED APPLICATIONS

This application claims priority to U.S. patent application Ser. No. 60/364,743, “Computer Implemented and/or Assisted Process and System for MerckMedicus” filed Mar. 18, 2002, incorporated herein by reference.

This application is related to the following U.S. Patent application: Attorney docket numbers 105456.121, 105456.123, 105456.124, 105456.125, and 105456.126, to the same inventors, and all of which are incorporated herein by reference.

### BACKGROUND OF THE INVENTION

1. Field of the Invention

The present invention is directed to computer related and/or assisted systems, methods, and computer program devices for an interactive continuing education system. More particularly, it relates to methods and systems for managing and/or providing continuing education activities, including for example healthcare continuing education, for users, e.g., physicians and other healthcare providers. Such invention may provide, e.g., a profile for viewing continuing education (CE) activities in a user's curriculum; characterizing educational progress of the user in connection with the user's licensure(s); managing the user's CE activities, including, e.g., submitting an activity for credit, launching an activity, etc.; maintaining a catalog of CE activities that may be added to the user's curriculum and/or launched; and/or a personal transcript manager.

2. Description of the Related Art

In the healthcare field, healthcare professionals conventionally may obtain information from medical publishers, with most of this information being just in print. On the other hand, academic institutions have considerable libraries, which unfortunately are not universally available to physicians. Hence, paper resources with healthcare information may be considerable but difficult to access.

In an attempt to provide information electronically, early websites with limited information were sponsored by a variety of commercial entities, academic institutions, or medical associations. There was, nevertheless, a lack of awareness among physicians of the web as a resource for providing information and/or other resources needed by physicians. Premium resources might be provided on some of these sites, nevertheless, there was limited exposure and/or access to these premium resources for physicians and other healthcare professionals.

These conventional means of providing information and other healthcare professional resources resulted in an uneven playing field for healthcare providers. In addition, there are a number of other hurdles facing office-based, rural and non-institutional healthcare professionals.

Physicians and other healthcare providers are presently adapted to the current situation. They are unlikely to change their current habits. Although there is a much greater degree of information available, unfortunately it will not find its way into the hands of physicians and healthcare providers, and ultimately will not result in improved healthcare. Nevertheless, the ability to save time and/or money is one of the primary motivators for physicians or healthcare professionals to change their habits.

Conventionally, the information and/or information gathering process is difficult and awkward for healthcare providers. The information might not be provided in one convenient place. Moreover, the information itself might be inconvenient. For example, if the information is provided by subscription, it is typically expensive to obtain multiple subscriptions. On the other hand information in textbooks might not be up-to-date. Further, textbooks, journals and libraries are not at all suited to physicians' nomadic working style, which typically includes travel between an office and a hospital. Information which might be provided over the web may be jumbled or confused, with multiple places, passwords, formats, browsers and search engines provided for a variety of information. Ultimately, physicians and other providers have entirely too many subscriptions, accounts, ID's and passwords, making the information awkward.

With regard to utilizing the Internet, the physicians might suspect the quality of information or services provided online. Moreover, such information and services might be biased, for example as a result of a sponsor of a particular product, unbeknownst to the users. Where information in sites is searchable, the search engines that are provided might not retrieve search results that are most relevant to the physicians' query.

In some situations, the access to information or services might be tied to a specific license or specialized access technology. For example, in order to obtain certain information or services, the physician might be required to use a specific computer or install certain technology.

In addition, sites that are provided by pharmaceutical companies do not tend to focus on physicians. These sites are product driven and patient oriented. They fail to provide for the needs of the physician as a customer. In short, it is difficult to obtain information or services via conventional methods.

One specific example of a website directed to physicians is Medscape/WebMD. Unbeknownst to physicians, however, Medscape/WebMD is commercially sponsored and exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time pressures, perhaps caused by busy practices and overwhelming paperwork. At the same time, healthcare practitioners face decreasing practice revenues. They also face information overload, with a decreasing amount of time to sort through the relevant information.

The inventors have determined that physicians or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms. It is estimated by the inventors that online CE is engaged in by 58% and 51% of primary care providers and physician specialists, respectively.

The inventors have determined that physicians refer to medical information sites primarily to find news and reference materials. In one study by the inventors in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online Courses | 29% |
| Patient Relationship Information and | 20% |
| Guides | |
| Clinical Trial Information and Links | 15% |
| Listing of Medical Organizations and | 7% |
| Meetings | |
| Financial and World News | 5% |
| Community and Messages Boards | 4% |

The inventors performed extensive research with physicians about website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:

Provides credible information

Provides quality information

Is easy to use*

Provides up-to-date health and medical information*

Enables effective research of usual cases or conditions

Is comprehensive

Offers premium medical resources not easily accessible elsewhere

Helps physicians communicate better with patients

Is available to doctors only and not general consumers

Offers ability to customize site based on preferences or specialty

Has a professional look and feel

Is unique from other sites

(*These attributes are less important to specialists than primary care physicians.)

Certain aspects of conventional systems for providing healthcare information are illustrated by way of example in FIGS. 1A-1B, also described in U.S. Pat. No. 6,283,761, Joao, incorporated herein by reference. In this healthcare information apparatus, the operation of the apparatus commences as Step 100. In Step 101, the individual utilizing a training simulator (e.g., provider, student provider, etc.) may access a central computer via an appropriate computer or communication device. At Step 102, the user may select the training program which they wish to train from. At Step 103, the central computer transmits the training scenario and/or information, including symptoms and/or conditions of a hypothetical patient, including, e.g. text, video, audio, and/or other multimedia information. At Step 104, the user enters their diagnosis and treatments for the scenario, and transmits to the central computer. At Step 105, the diagnosis and treatment are applied. At Step 106, the central computer compares the diagnosis against those known to be correct or against scientific and statistical norms; and the central computer applies the prescribed treatments to the hypothetical patient and computes revised set of symptoms or conditions. At Step 107, the central computer transmits a response to the diagnosis and prescribed treatment, e.g., the patient's response and/or evaluation of diagnosis and prescribed treatments. The response may include training material. At Step 108, the user reviews the material in the response and decides whether or not to continue the training. At Step 109, the user transmits a response to the central computer indicating whether or not to continue the simulation, and may include a revised diagnosis and treatment. At Step 110, the central computer processes the user's response. At Step 111, the central computer determines whether the user wishes to continue the simulation or terminate. If at Step 111, the user wishes to continue the training simulation, the operation returns to Step 105 and repeats. On the other hand, if the user wishes to terminate training, operation ceases at Step 112. User responses can be recorded and the information may be utilized to evaluate the user's progress, improvements, aptitude and skills.

Other aspects of conventional systems are illustrated by way of example in FIGS. 2A-2B, also described in U.S. Pat. No. 6,263,439, Hondros et al., incorporated herein by reference. In this verification system for non-traditional learning operations, the registrant logs onto the Internet and accesses a webpage by either an accredited agency or course provider 200. In order to effect CE, a menu of available courses 201 is displayed, as well as an ability to register and activate the course. Available courses may be added to a shopping cart 202 with a further description available 203 to aid the participant in course selection. The materials may be stored locally 204 with the capability of downloading and printing course materials 205. After a course is selected, online registration 206 is available. From the selected courses 207, a personal ID and course purchasing record is generated 208. This material is stored on a registration server 209 and an encrypted batch file may be obtained by the course provider 210. After completing the registration process 211, a “pin” number is generated with the option of returning to the main menu 201 or proceeding to begin the course 212. If the user opts to proceed, then the database is checked for the registrant's record 214, followed by course sign-on including the ID and assigned “pin” 215. If a mismatch is detected, the user goes back to the main menu 201. If a match is found 216, then the registrant is permitted to review the access webpage 218 with links to the course and personal information. Upon activation of the selected course 220, the material 221 is downloaded 223 in a format suitable for printing. An optional plug-in is available for email and Internet access 224. After reviewing the course content, the applicant moves to the testing phase to determine mastery of the subject matter 222. Various questions are answered 225 with subsequent grading 226 in data achieve 227. The course providers may cross check for registrant payment 228 with notification of the accrediting agency 229. If there is a problem with a payment, the registrant may be notified 230, resulting in a notification of the accrediting agency 229.

The above prior art references, however, fail to meet the needs of today's medical community. For example, we have determined that physicians and healthcare professionals would prefer a website with cutting edge tools and resources, available in a single portal, as a key to the medical Internet. We have determined that physicians and other healthcare providers would prefer that such a site is ethical, credible, insightful, unbranded and objective. We have further determined that such a site should be for physicians and healthcare professionals, and provide access to premium medical resources.

Unfortunately, conventional systems failed to meet these needs of physicians. Moreover, none of these conventional systems specifically provide an online unified method for accessing, completing and tracking continuing education activities of the physician or healthcare practitioner's choice, towards the continuation of their professional development. Moreover, using conventional systems, it is not possible to rapidly search for and/or locate relevant content, maintain a personal curriculum, bank continuing education credits from both online as well as offline activities, track and print a professional transcript, and more. There remains a need for such assistance for physicians and other healthcare practitioners.

### BRIEF SUMMARY OF THE INVENTION

The present invention alleviates the deficiencies of conventional techniques and systems described above. The invention enables information provision to physicians and other healthcare providers that is more targeted, more efficient and may be permission-based. The invention provides assistance to help physicians to obtain timely and appropriate information to help them practice better medicine. The system, according to one or more aspects of the invention, provides the right information in an appropriate format. It also provides for appropriate filtering of information. Another enduring value which the invention provides to physicians is an aggregation of resources in one place. The present invention provides a fairly easy way of distributing information targeted to certain physicians, and allowing those physicians to expose themselves more readily to new information. The present invention fosters the best practice of medicine, which creates simultaneous benefits for physicians, patients, and continuing education providers.

The present invention may bring together a vast collection of resources available to physicians. The invention may provide a content library unmatched in its breadth. It optionally may provide a search engine appropriate for perusing, e.g., Harrison's Online, Cecil's Textbook of Medicine, Praxis.md, the Merck Manual and many others. In addition, it may provide one or more links to searches such as MD Consult which offer their own extremely comprehensive library. All told, these many resources may cover primary care and just about every specialty imaginable. Users may utilize a global view or personalize their experience by choosing a specialty view, each of which may be a portal in itself. An optional folder feature may allow physicians to document their visits with extensive bookmarking to track their progress (e.g., previously conducted searches, research links). The invention may include a comprehensive professional development area with board review questions, a medical meeting calendar with unique content from many meetings and the ability to earn CME credit through a partner site. The patient resource area may exceed that of most physician web portals, and optionally may include access to an immense collection of patient handouts that physicians may easily print. Other resources may include coverage of what patients are seeing in the media, color illustrations and easy-to-read descriptions for numerous medical procedures, and resources to help locate clinical trials for patients. Clinical workflow tools optionally may include clinical calculators, an ICD-9 search engine, drug interaction checking, and expert systems that assist with antibiotic choices (ThereDoc™) and difficult differential diagnoses (Dxplain™). Optionally, an electronic assistant provides quick links to relevant news and journals, career information and clinical decision support tools that may optionally be downloaded to a physician's handheld computer. A number of unique and powerful features may be provided, such as free access to subscription sites (e.g., Harrison's Online, Praxis.md, MD Consult). Another interesting optional resource is a lectures and presentations builder, allowing users to prepare custom slides for incorporation into, e.g., PowerPoint documents, and including, e.g., public speaking advice.

According to one or more embodiments of the present invention, there is provided a single online destination with a library of continuing education activities, particularly continuing medical education activities. The site advantageously is interactive and convenient, while automating the tracking, organization, and management of a healthcare professional's healthcare education portfolio.

The present invention may include a library of continuing education content, preferably dynamic, and preferably from current thought leaders and renowned continuing education providers. Activities could be included for example from CE providers such as Healthstream, Mypatient.com, CECity, Healthanswers.com, and others. According to one or more embodiments of the present invention, a user may access activities from national or international institutions, e.g., the Cleveland Clinical Foundation, the University of Alabama School of Medicine, Columbia University, and more, without leaving home or office, 24 hours a day, 7 days a week-at a time and place that fits the healthcare professional's schedule.

In accordance with one more embodiments of the present invention, the user may be provided with a secured, personal account, through which the user may access and/or complete activities of the user's choice towards the continuation of the user's professional development. Optionally, the present invention includes a search engine in order to rapidly locate relevant content. Further, optionally, the present invention provides a system which allows the user to maintain their personal curriculum, to bank their continuing education credits from both online as well as offline activities, and/or to track and print their professional transcript. Optionally, according to one or more embodiments of the present invention, the user may customize their account to meet their professional preferences. Accordingly, the system may alert the user, e.g., via email, as new activities are added to the catalog of CE activities, within their specified field or fields or interest. Further, the system may act as a personal education assistant, alerting a user as new activities are launched, in order to address cutting-edge medical issues.

The invention provides a method, system, and computer program device for a computer-based system for managing and/or providing continuing healthcare education (CE) activities, an interactive CE system for users including physicians and healthcare providers, implemented by a computer system. The interactive CE method, system or computer program device includes a personal profile, providing information representative of a user's educational progress characterized by one or more CE activities in a curriculum of the user, against licensure requirements for one or more jurisdictions selected by the user. It also includes a curriculum manager, providing information representative of the current CE activities in the curriculum of the user. It further includes a catalog browser search engine, searching a catalog of CE activities to locate CE activities of interest for the user. Further, it includes a personal transcript manager, tracking compleated online CE activities of the user in a transcript for the user.

Optionally, the information representative of the user's educational progress is further characterized by a time remaining in a licensure period for the selected one or more jurisdictions. Optionally, the personal profile further includes at least one of: providing data indicative of at least one CE activity in the user's curriculum; adding at least one CE activity to the user's curriculum; listing one or more CE activities that are open in the user's curriculum; providing information about CE requirements for one or more specified jurisdictions; providing information about the one or more open CE activities and a status of the user's progress in the open CE activities; and configuring the one or more licensure periods for the user for at least one of the jurisdictions.

Optionally, the information provided by the curriculum manager representative of each of the current CE activities further includes, for each CE activity, at least one of: a status of the CE activity and the user's completion thereof, a number of credit hours for the CE activity, date of last access of the CE activity by the user, and an indication of whether the CE activity has been submitted for credit. Optionally, the curriculum manager adds and/or removes at least one CE activity in the user's curriculum. The curriculum manager optionally launches one or more CE activities in the user's curriculum.

The catalog browser search engine optionally includes a search locating activities based on single, user-defined categories available within the catalog; and/or a search wizard searching by one or more of: profession, topic, product category, condition, disease, disorder, keyword, and phrase. Optionally, the catalog browser search engine includes a display screen having information about the located at least one CE activity, the information including one or more of: brief description, the number of credit hours, professional accreditation, prior user ratings; a first means for adding an activity to the user's curriculum; and a second means for launching a selected one of the CE activities and adding the selected one of the CE activities to the user's curriculum.

According to one or more optional embodiments of the present invention, the personal transcript manager tracks online CE activities and/or offline CE activities. Optionally, the offline CE activities are tracked by allowing transcript data to be entered for the offline CE activities; and/or the online CE activities optionally are tracked by accessing online CE information to automatically update transcript data. Optionally, the personal transcript manager displays CE activities completed by the user in relation to at least one of jurisdiction and period of licensure. According to a further optionally embodiment of the present invention, the personal transcript manager reprints a certificate for CE earned by the user; and at least one of generates and customizes at least one of the transcripts and a report showing at least one of accredited CE activities, non-accredited CE activities, and completed CE activities, in the user's transcript.

According to one or more optional embodiments of the present invention, the system, method and/or computer program device includes an account manager allowing a user to at least one of view and change account information in the user's account, including for example modifying contact information, personal information, one or more jurisdictions of licensure, and profession.

A further optional embodiment of the present invention includes a showcase system displaying information concerning at least one of selected CE activities and selected libraries in the interactive CE system, including shortcuts to locate the selected CE activities and the selected libraries; adding one of the selected CE activities to the user's curriculum; and launching the one of the selected CE activities.

According to another optional embodiment of the present invention, there is provided a preference manager, determining to alert the user if at least one activity of interest is added to the catalog. Optionally, the preference manager further includes at least one of creating and editing a set of user preferences including at least one user preference, and notifying the user of one or more CE activities added to the catalog and which match the at least one user preference.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIGS. 1A and 1B are an illustration of a prior art apparatus and method for providing healthcare information, including processing of symptom information, diagnosis and treatment for a hypothetical patient.

FIGS. 2A and 2B are a flowchart of a prior art verification system for non-traditional learning operations.

FIG. 3 is a functional block diagram illustrating an example of an interactive continuing healthcare education (CE) system, according to one or more embodiments of the present invention.

FIG. 4 is an exemplary user interface illustrating a personal profile option in accordance with one or more embodiments of the present invention.

FIG. 5 is an exemplary user interface illustrating licensure information for use in connection with the optional personal profile of FIG. 4.

FIG. 6 is an exemplary user interface illustrating additional licensure input, for use in connection with the personal profile of FIG. 4.

FIG. 7 is an exemplary user interface illustrating a curriculum manager, for use in connection with one or more embodiments of the present invention.

FIG. 8 is an exemplary user interface illustrating an electives menu, for use in connection with the curriculum manager of FIG. 7.

FIG. 9 is an exemplary user interface illustrating a catalog browser search engine option, in accordance with one or more embodiments of the present invention.

FIG. 10 is an exemplary user interface illustrating a basic search option, for use in connection with the catalog browser search engine of FIG. 9.

FIG. 11 is an exemplary user interface illustrating an optional search wizard for use in connection with the catalog browser search engine of FIG. 9.

FIG. 12 is an exemplary user interface illustrating search results resulting from a use of the catalog browser search engine of FIG. 9.

FIG. 13 is an exemplary user interface illustrating a personal transcript manager option, for use in connection with one or more embodiments of the present invention.

FIG. 14 is an exemplary user interface illustrating a transcript menu, for use in connection with the personal transcript manager of FIG. 13.

FIG. 15 is an exemplary user interface illustrating a transcript report menu, for use in connection with the personal transcript manager of FIG. 13.

FIG. 16 is an exemplary user interface illustrating a continuing education transcript, resulting from the personal transcript manager of FIG. 13.

FIG. 17 is an exemplary user interface illustrating a CME certificate available from the personal transcript manager of FIG. 13.

FIG. 18 is an exemplary user interface illustrating the addition of an external CE activity via the personal transcript manager of FIG. 13.

FIG. 19 is an exemplary user interface illustrating an account manager option, according to one or more embodiments of the present invention.

FIG. 20 is an exemplary user interface illustrating updating the user's account, in connection with the account manager of FIG. 19.

FIG. 21 is an exemplary user interface illustrating a showcase system option according to one or more embodiments of the present invention.

FIG. 22 is an exemplary user interface illustrating a preference manager option, for use in connection with one or more embodiments of the present invention.

FIG. 23 is an exemplary user interface illustrating a menu for setting up user preferences, for use in connection with the preference manager of FIG. 22.

FIG. 24 is a block diagram of a computer used for implementing one or more embodiments of the interactive CE system, in accordance with a computer implemented embodiment of the present invention.

FIG. 25 illustrates a block diagram of the internal hardware of the computer of FIG. 24.

FIG. 26 illustrates a block diagram of an alternative computer of a type suitable for carrying out the present invention.

FIG. 27 is a flowchart illustrating one or more embodiments of the personal profile, in accordance with the present invention.

FIG. 28 is a flowchart illustrating one or more embodiments of the curriculum manager, in accordance with the present invention.

FIGS. 29A-29B are a flowchart illustrating one or more embodiments of the catalog browser, according to the present invention.

FIG. 30 is a flowchart illustrating one or more embodiments of the transcript manager, according to the present invention.

FIG. 31 is a flowchart illustrating one or more embodiments of the account manager, according to the present invention.

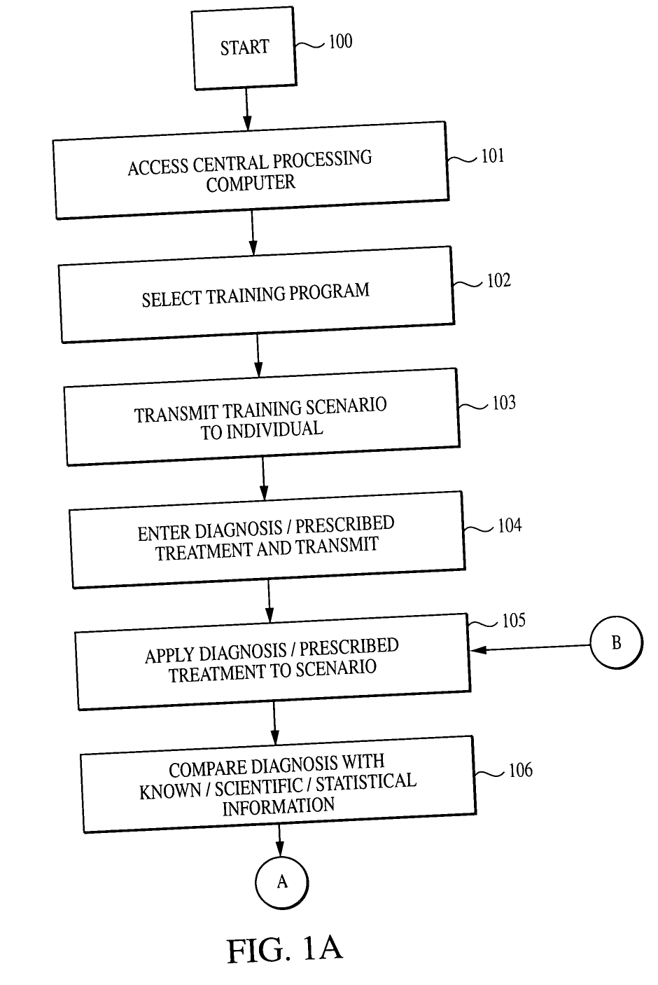

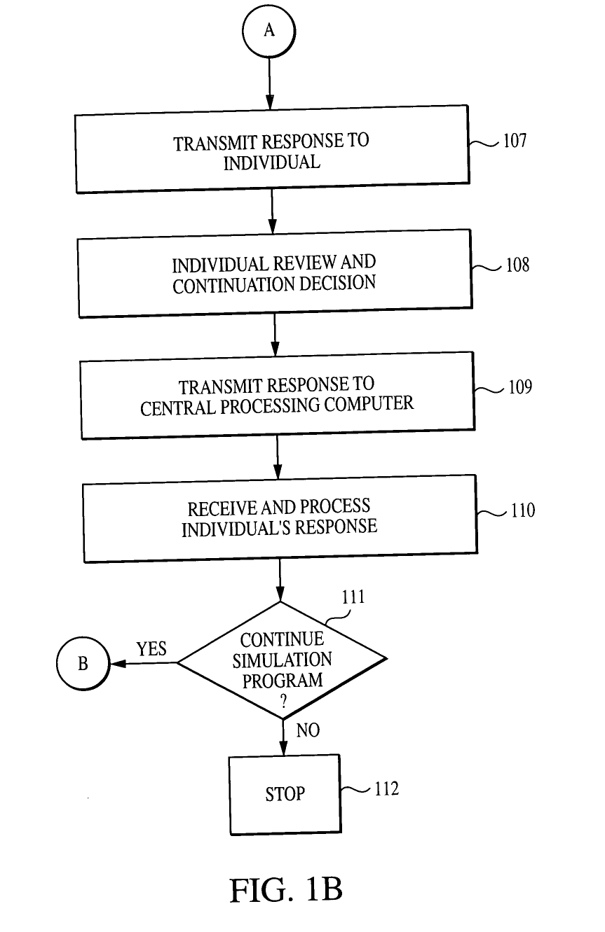

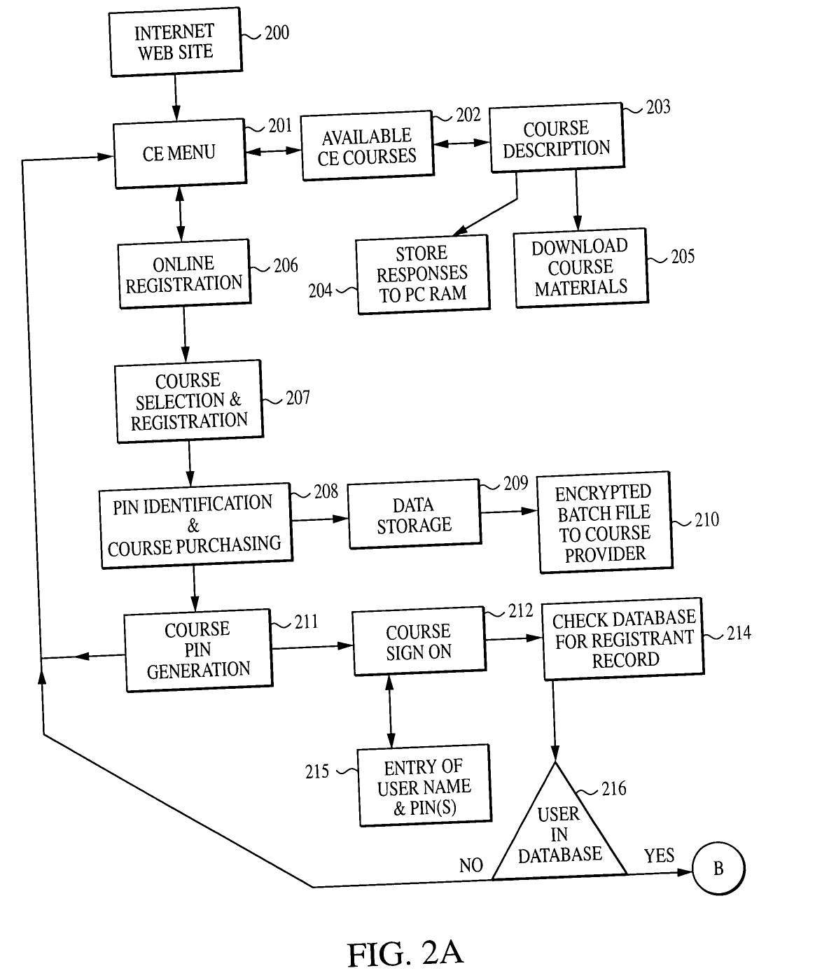

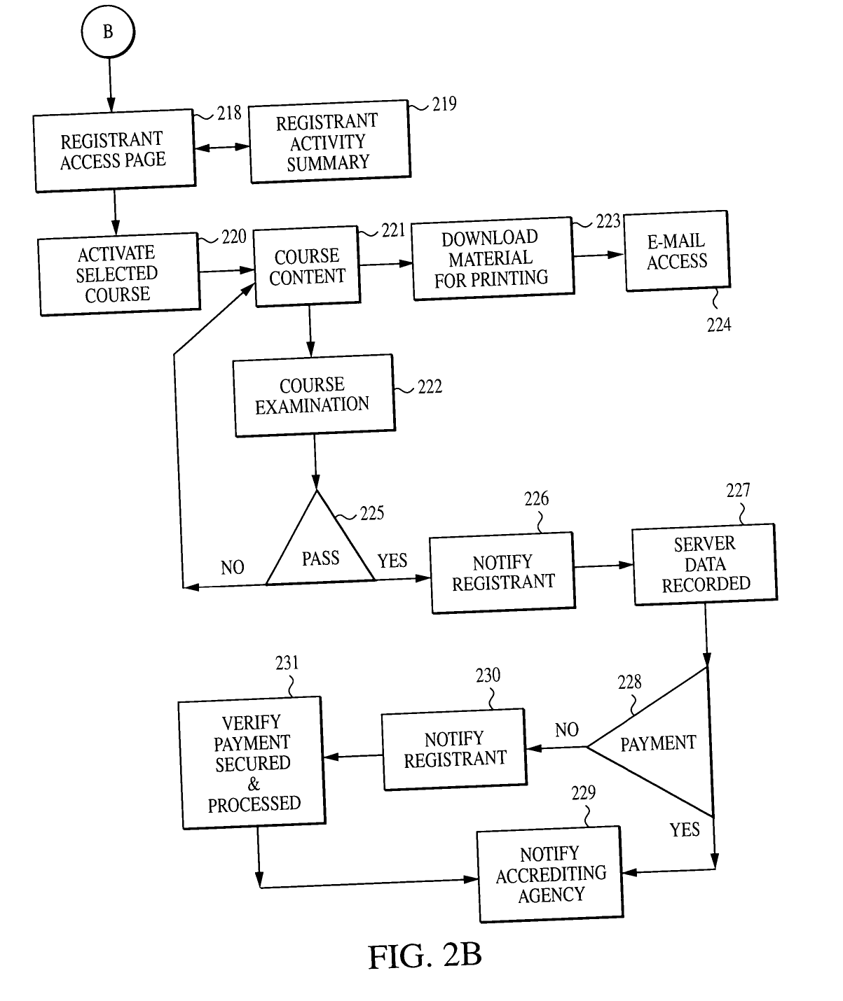

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

The present invention provides for online continuing healthcare education and professional development, in a destination for which a library of continuing education (CE) activities may be accessed in a manner which is interactive and convenient, while automating the tracking, organization and management of a healthcare professional's healthcare education portfolio.

The present invention may include a range of learning management tools, for example the functions of a secure, personal account; the ability to access and/or complete activities of the user's choice; a CE catalog with a search engine; the ability to maintain a personal curriculum, the ability to bank continuing education credits, including e.g., online and offline activities; and/or tracking and printing professional transcripts.

The present invention may provide one or more of the following benefits for online continuing healthcare education: a single online CE destination with a library of CE activities; a medical CE portal making the CE experience easy, interactive and convenient; automated tracking, organization and management of a user's professional healthcare education portfolio; and/or a personal education assistant, alerting a user to new activities of interest as they are added to a course catalog.

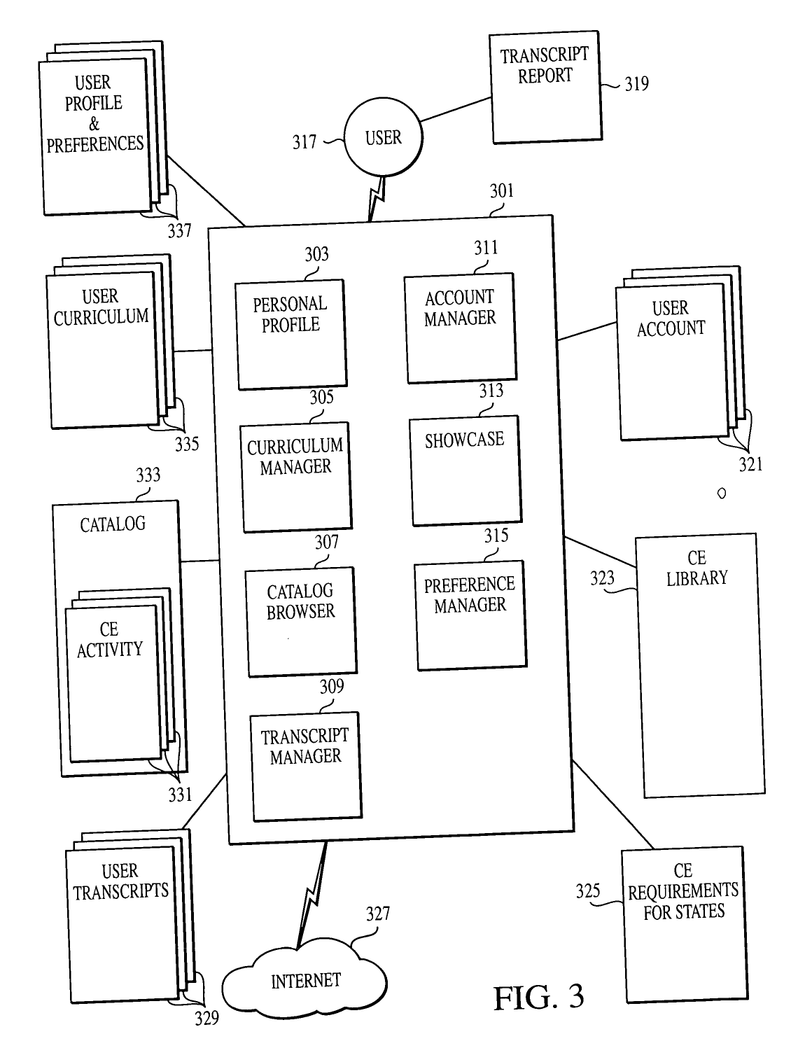

FIG. 3 provides a block diagram of one or more embodiments of the interactive CE system, according to the present invention. Preferably, the CE system is implemented on a computer system 301, which may be accessed by one or more users 317. The users may communicate with the system, preferably as a portal over the Internet 327.

The CE system may include one or more of the following features: a personal profile 303, a curriculum manager 305, a catalog browser 307, a transcript manager 309, and account manager 311, a showcase 313, and/or a preference manager 315.

The computer system 301 may access and/or store a variety of information, for example, user account data 321, a CE library 323, information regarding CE requirements for states 325, one or more transcripts 329 for the users, various CE activities 331 which may be offered for the users, such as via a catalog 333, individual curriculums 335 for each user, and/or individual user profile and preferences 337 for each user.

It should be understood that the invention is described in connection with logical groupings of functions. One or more of these logical groupings may be omitted from one or more embodiments, and still remain within the scope of the present invention. Likewise, functions may be grouped differently, combined, or augmented without parting from the scope of the invention. Similarly the present description may describe various databases or collections of data and information. One or more groupings of the data or information may be omitted, distributed, combined, or augmented, or provided locally and/or remotely without departing from the scope of the invention.

The present invention may provide a user with a personalized center for continuing medical education and professional development. The user may be a physician or other healthcare professional. The system may to provide the user with expanded online access to high quality continuing education programming. The system may respond to the shifting needs of healthcare professionals, who are constrained to find practical ways to incorporate CE into their business schedules. Further, the present invention is intended to provide seamless access to the user's activities, while maintaining privacy and convenience.

According to one or more embodiments of the present invention, the user is provided with a personal account from which the user may search for CE activities of interest, and/or build their personal curriculum. The system may automatically create a digital transcript, in order to track successfully completed on-line CE activities. Moreover, the system may include the ability to add external activities to the user's transcript, in accordance with one or more embodiments of the present invention. Examples of such activities might include CE completed through journal-based home study programs, as well as live events. These and other features enable a user to interactively manage their continuing education experience, even from their own home.

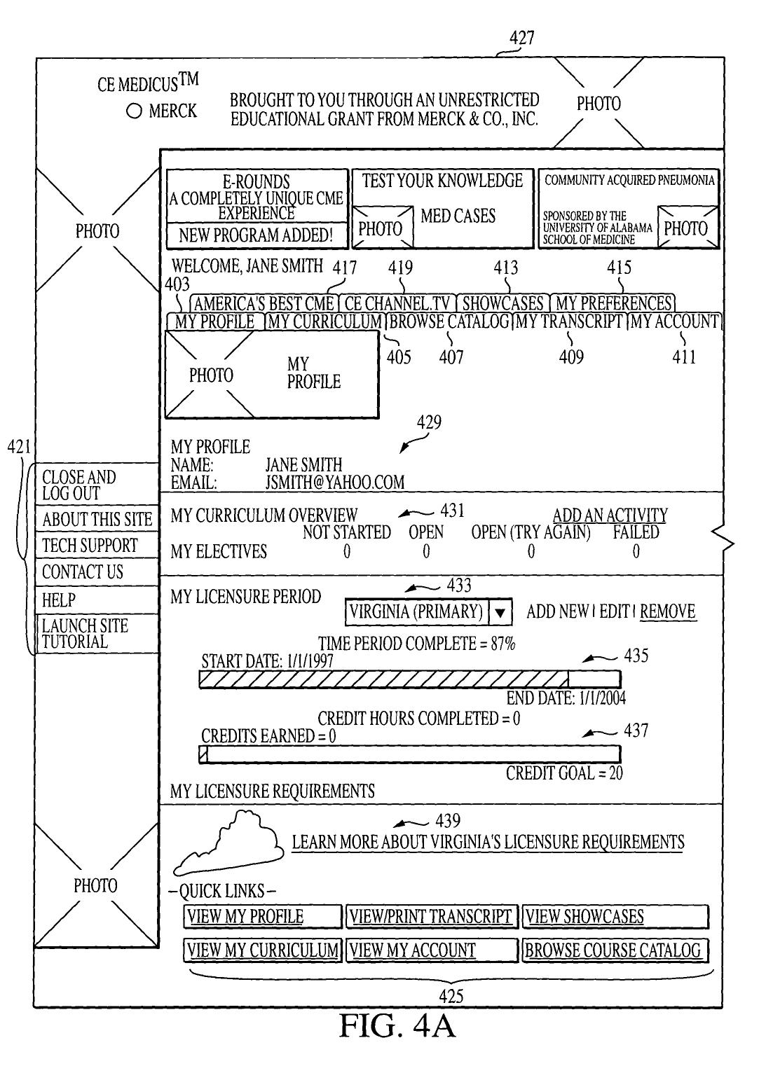

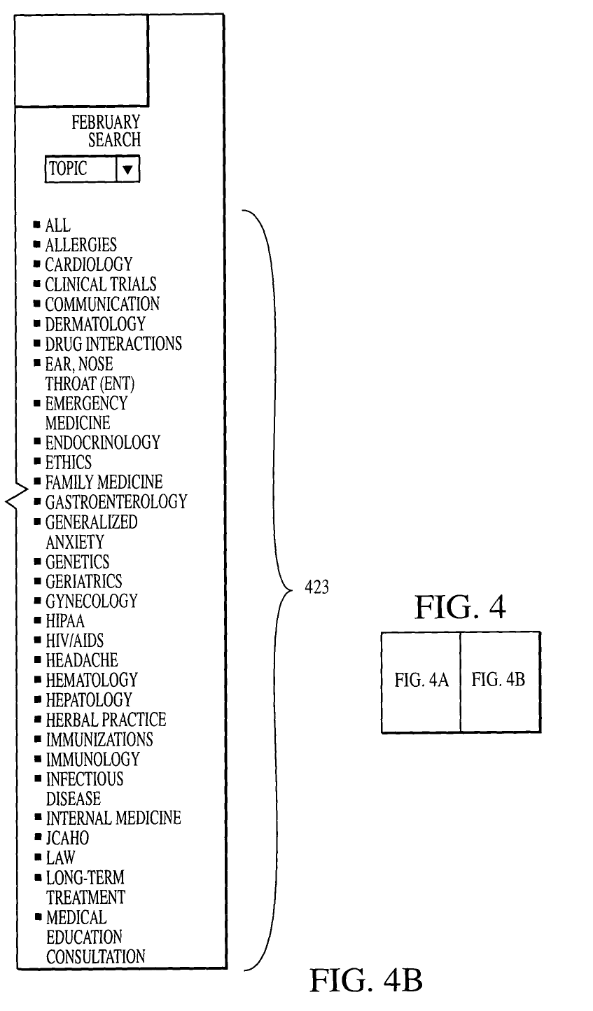

According to one or more embodiments of the present invention, the user registers or otherwise logs into the system. The user then arrives within their own personalized account at the personal profile page, illustrated for example in FIG. 4. According to one or more embodiments of the present invention, this personal profile page may serve as the home page for the user, and/or provide a snapshot of the user's CE progress. It may serve as a starting point for all of the user's CE activities.

Further, this initial page may provide for navigation among the site, according to one or more embodiments of the present invention. Referring to FIG. 4, one or more general information links 421 may be provided. These links may include information about the site, such as “about this site”, text support, contact information, help information, logout ability, and/or a site tutorial. The general information links may be persistent on the user interface while the user accesses the system.

Optionally, one or more banners 427 may be located on one or more pages to provide ready access to one or more featured CE activities or special offers. Selecting one or more of the featured CE activities or special offers may locate the activity or link to additional information about the activity or offer.

The present invention may provide one or more ways to search against the catalog in order to locate CE activities of interest. In the illustrated example user interface, one such search 423 is presented as a quick method for locating activities based on a single category. Categories could include, for example, topics, content source, content type, disease, and product category. By utilizing e.g., a drop-down box in the present example, a user may select a category and the system will search the catalog and return a list reflecting the appropriate CE activities from the catalog. Optionally, the user may then select an item from the search results, e.g., click a link to locate and/or optionally commence one or more CE activities.

The user may also access, optionally from the homepage, features provided by the interactive CE system. The features may be grouped by function. According to one or more embodiments of the present invention, convenient feature groups may include one or more of a personal profile 403, a curriculum manager 405, a catalog browser search engine 407, a personal transcript manager 409, an account manager 411, a showcase system 413, a preference manager 415, and/or additional content as selected, e.g., by the site administrator 417, 419. Navigation among features and/or features groups may be provided via, for example, the illustrated tabs as navigation tools that allow the user to move quickly between sections of the user's account. By utilizing the illustrated tabs, the user may easily maintain their curriculum, perform a more detail search of the catalog, maintain their transcript, and generate reports, for example. Features may, if appropriate, be accessed from more than one feature group.

Referring now to the “my profile” 403 tab of the user interface, the personal profile feature group is intended to provide a snapshot of the user's CE activities and CE requirements. Features may include, e.g., summarizing the user's current educational activities, adding new CE activities to the user's curriculum, viewing and managing educational progress in relation to the user's licensure period, and/or to providing information about one or more state's professional CE licensure requirements. In the illustrated example, the user interface provides user name and contact information 429, a curriculum overview 431, a definition of the licensure period 433, a visual display of the time complete in the licensure period 435, a visual display of the CE credits earned in the licensure period 437, and access to licensure requirements corresponding to the user's licensure jurisdictions 439. Optionally, the user may indicate and/or information may be provided on multiple licensure jurisdictions.

Optionally, the interactive CE system provides quick links to the various sections of the interactive CE system 425. The optional quick links may be included on one or more pages of the use interface.

The curriculum overview 431 provides a summary of relevant curriculum information for the user may readily determine their CE status. For, example, as illustrated, the system may provide a high level summary of CE activities that are currently open within the user's curriculum, and the status of the user's progress within each activity. Optionally, a link or other access may be included to allow the user to add an activity, for example, by searching the catalog and adding an activity to the user's curriculum or immediately starting the new activity.

When initially entering the user's account, the user may be queried in order to configure one or more licensure periods. This may include the licensure jurisdiction, e.g., state of licensure, as well as the licensure time and credits needed to be earned during the licensure period. Optionally, a transcript described herein may default to the parameters set by the user in the licensure period. Optionally, the system automatically determines the licensure requirements conforming to the selected licensure jurisdiction(s), e.g., via databases(s).

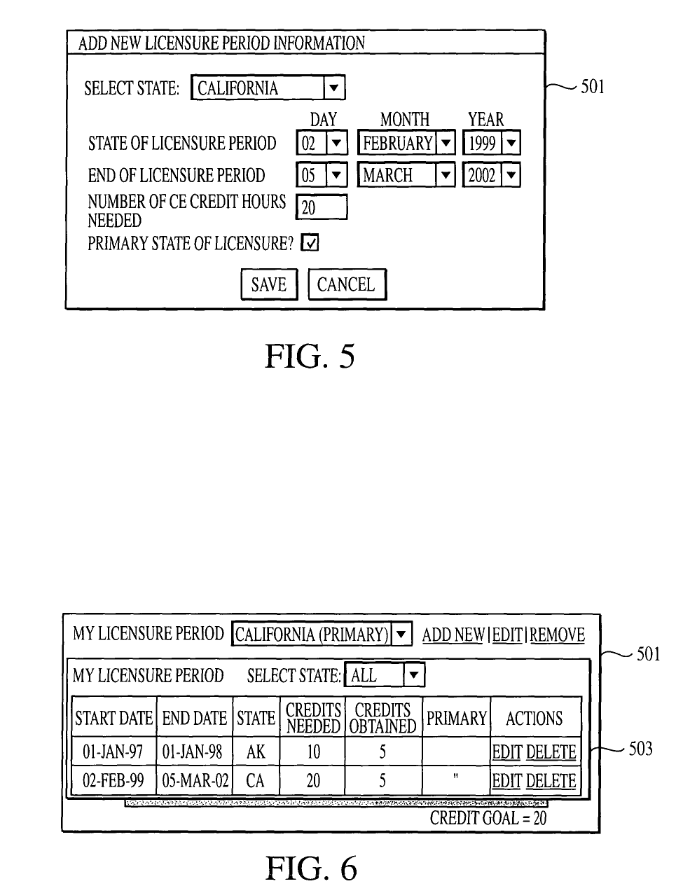

Reference is made to FIG. 5, illustrating one embodiment for the addition of licensure period information 501. The user selects a state of licensure, and begin and end dates for their current licensure period. The user is also prompted to enter the number of credit hours required by that state. A user may be licensed in more than one jurisdiction, and hence the invention preferably tracks progress for each jurisdiction. A primary jurisdiction of licensure may be indicated, which may be displayed by default.

Once the licensure period is configured or otherwise determined, it may display a visual tool, for example the illustrated bar graph 435, 437 of FIG. 4, comparing the time remaining in the user's current licensure period against the total number of credit hours achieved or otherwise indicating the user's credit hour progress against the licensure period and/or licensure requirements. The CE progress visual tool may update automatically as CE activities are added to the user's transcript. The licensure requirements 439, illustrated in FIG. 4, may be utilized to look up and review profession and state-specific CE requirements for licensure and re-licensure purposes.

Reference is made to FIG. 6, in which the user has multiple licensure jurisdictions. The user may edit or delete information regarding the licensure periods in these states, and their licensure states will likewise be tracked.

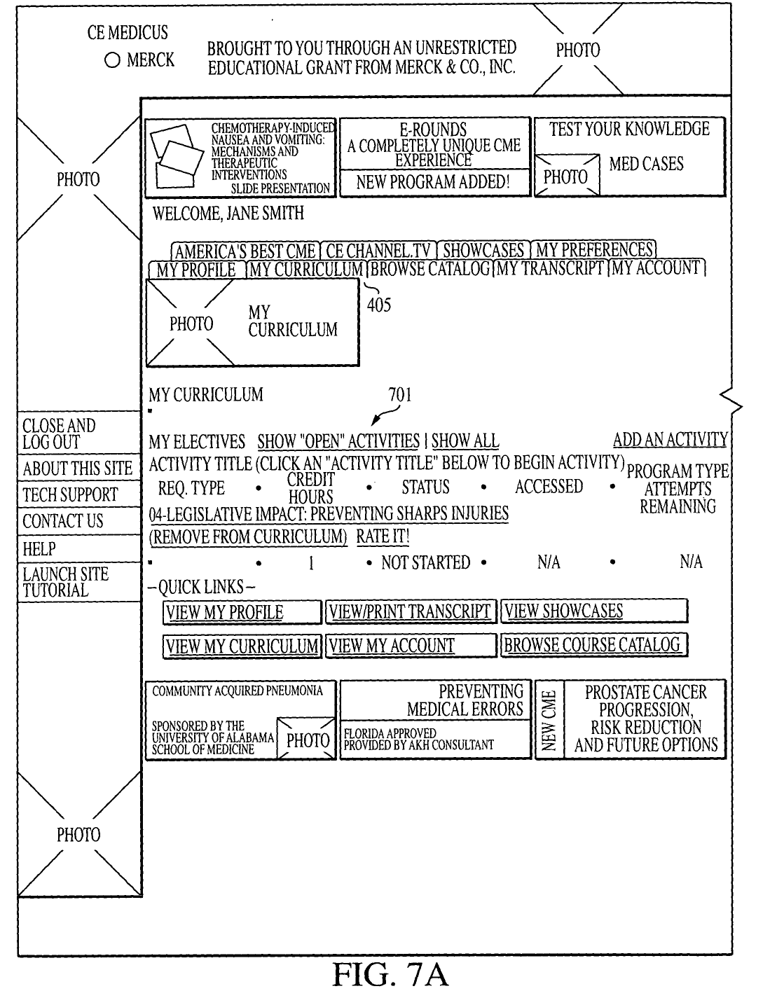

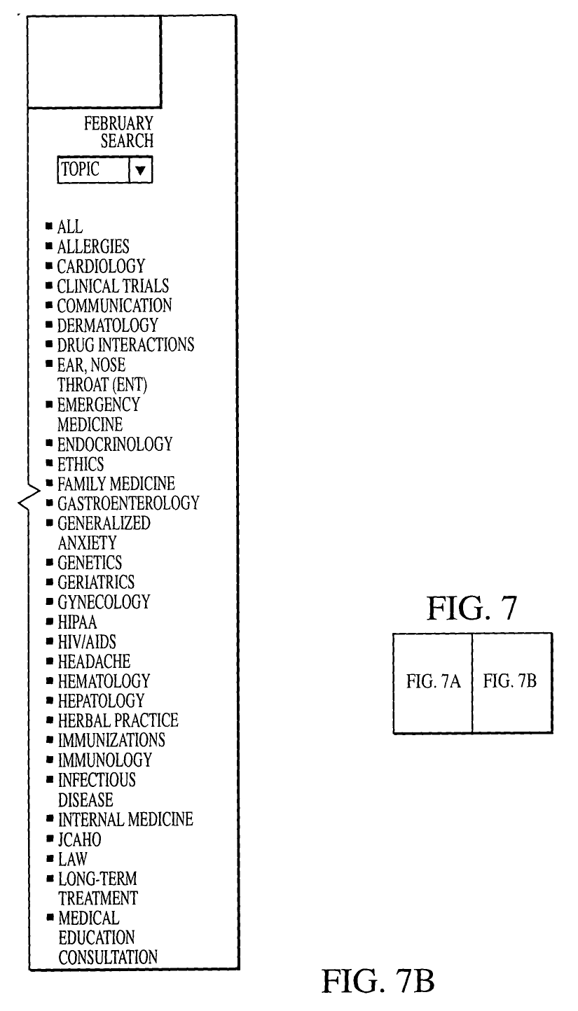

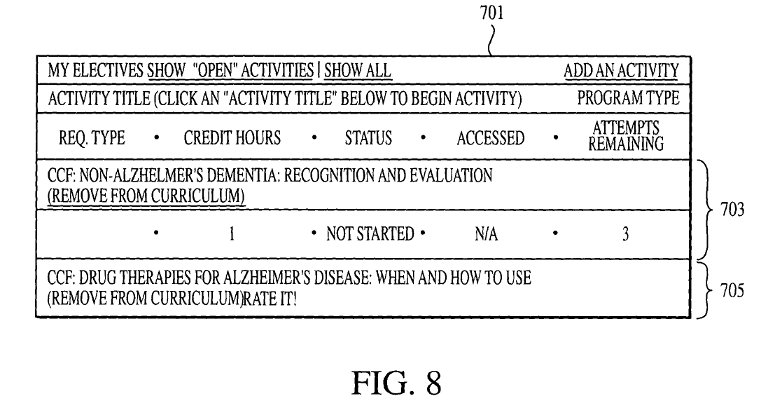

Reference is made to FIG. 7, illustrating one example of the curriculum manager 405. The user may access their curriculum manager, which provides detailed information and/or the status of CE activities that are included in the user's curriculum. Information, including for example the number of credit hours that are available for that activity, the date of last access, and whether or not the activity has been submitted for credit may be available from this section. The user may add new CE activities to their curriculum, for example by clicking an “add an activity” link. Adding an activity optionally will launch the user into the catalog feature, where the user may search for and optionally select an activity of their choosing. From there, optionally, the user may launch directly into the activity or add the activity to the curriculum. In the curriculum manager 701, detailed information about the elected activities may be shown, as illustrated for example in FIG. 8. One or more CE activities 703, 705 may be summarized in the user's curriculum. The user optionally may launch directly into one or more CE activities listed within their curriculum, for example by clicking on the activity.

A user may also delete a CE activity. Optionally, the user may not delete an activity that has already been completed. Optionally, this view shows only open activities, i.e., those CE activities which have not been completed and approved for CE credit. Alternatively, the user may view open activities, as well as a list of activities which have been completed and/or approved for CE credit.

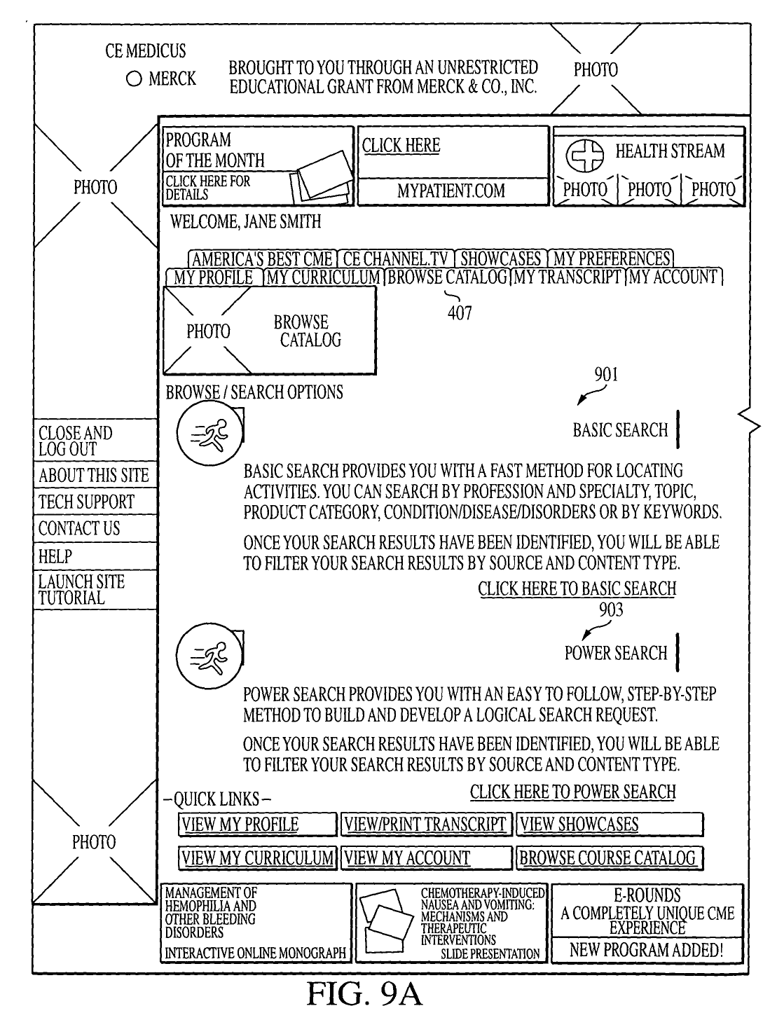

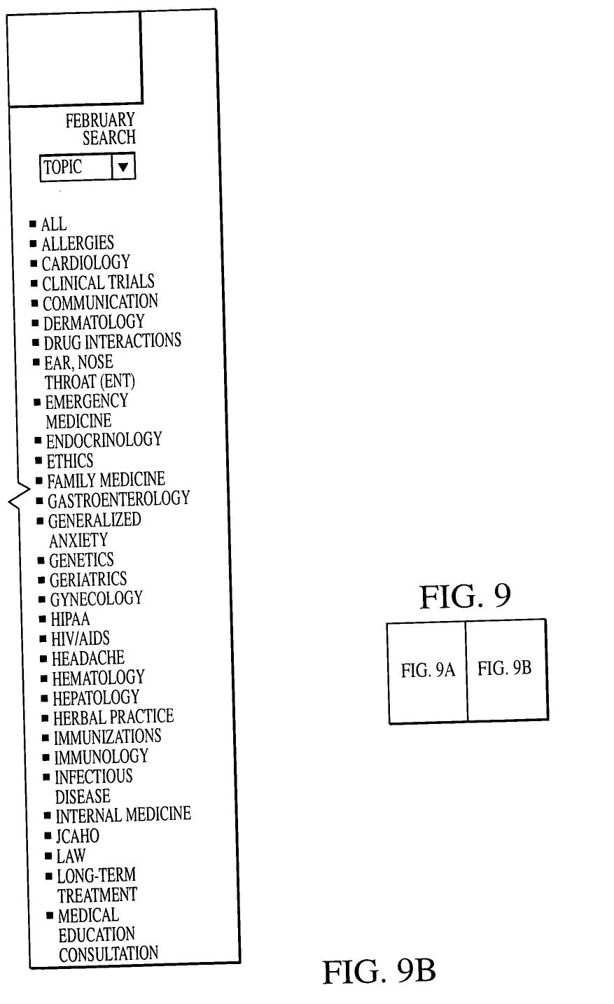

Reference is made to FIG. 9, illustrating one embodiment of a catalog browser search engine. The interactive CE system provides one or more ways for the user to search, browse, or otherwise review the catalog of CE activities, in order to locate activities of interest to the user. Accordingly, in the illustrated embodiment, the catalog browser search engine optionally may provide a basic search feature 901 and/or a search wizard feature 903. Basic search is intended to provide a quick method for a user to locate CE activities, based on a single user-defined category available within the catalog. The wizard search is intended to assist the user in defining and performing, a more complex search. Other searches may be implemented in other embodiments of the invention.

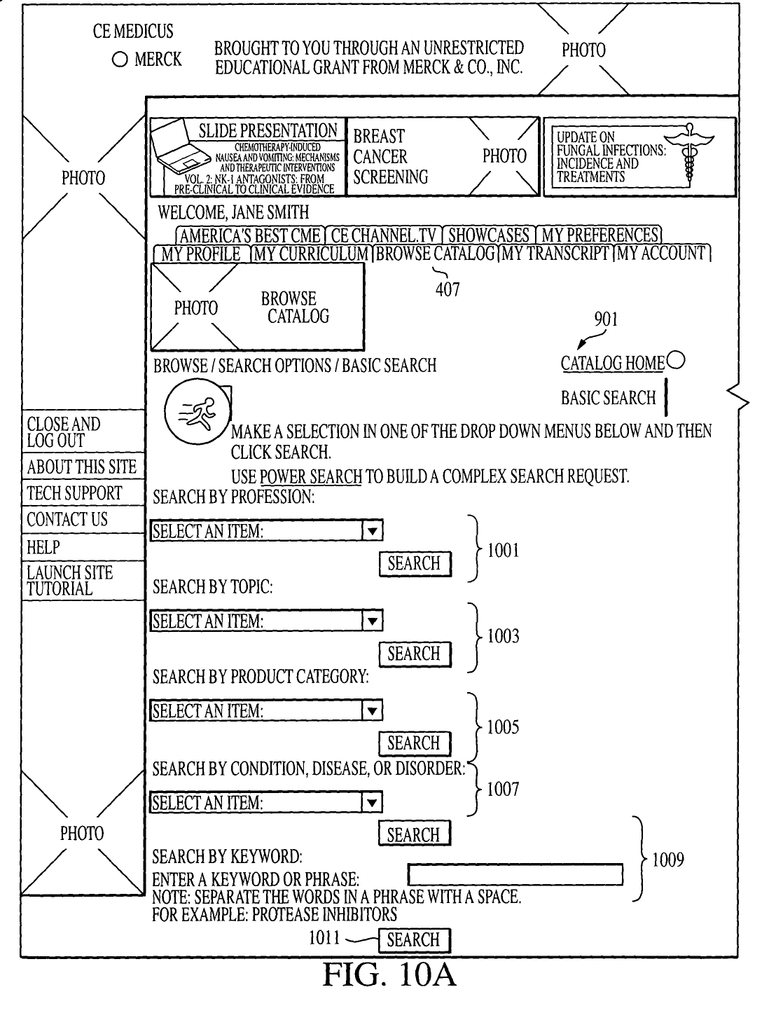

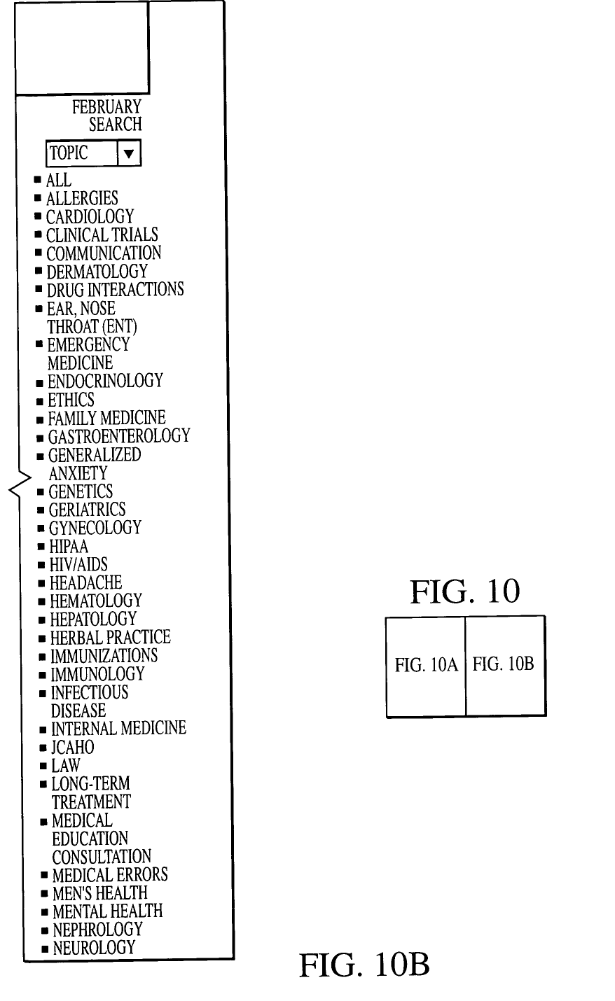

Reference is made to FIG. 10, illustrating one embodiment of the basic search 901. In this example, the user is prompted to select an item from one of several search categories: profession 1001, topic 1003, product category 1005, condition, disease or disorder 1007, and/or keyword 1009. A pull down menu of search term any optionally be provided. After selecting a category and search term, the user may initiate the search, e.g., may click on the search button 1011, and return the search results.

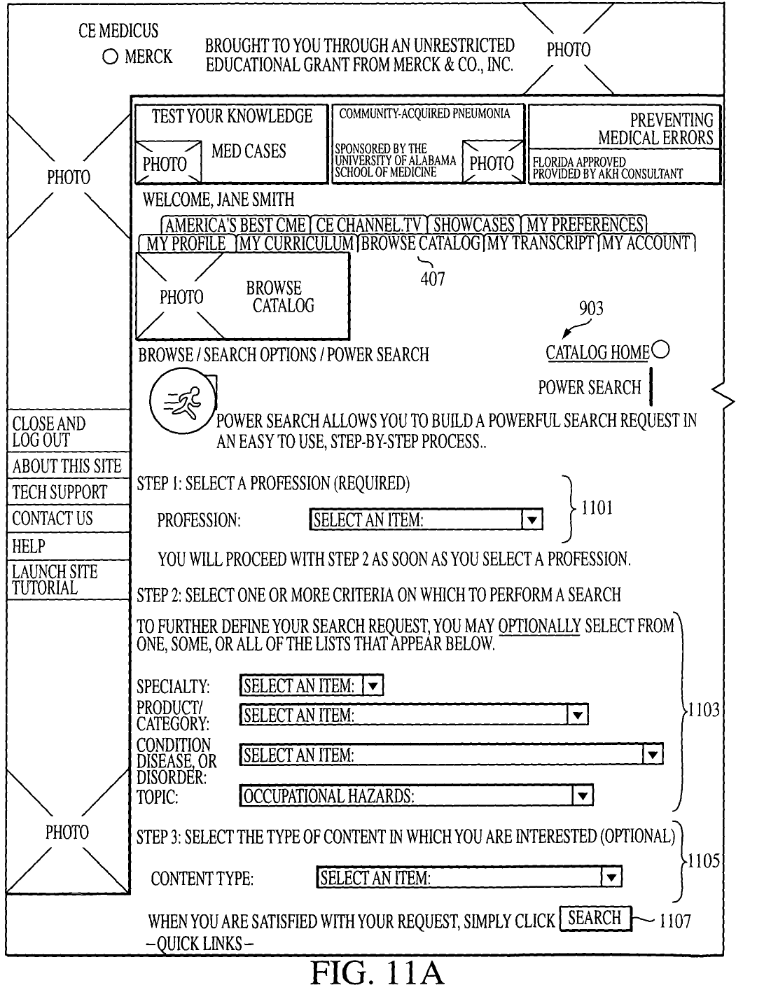

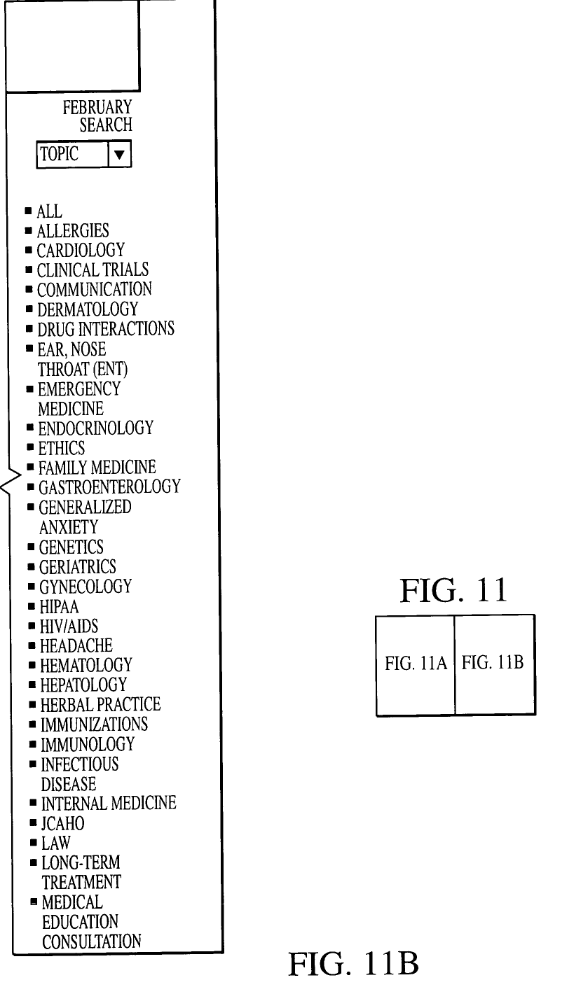

Reference is now made to FIG. 11, illustrating a search wizard feature 903 for a more complicated search of the catalog. The search wizard is one way to assist the user to build a multi-item search request. In the illustrated example, the user selects a profession 1101, and selects one or more additional search items, e.g., specialty, product/category, condition, disease or disorder, topic, and/or content type. When the user is satisfied with the selections for their search requests, they may click on the search button 1107 to initiate the search and return the search results. In the present example, the search requires that the user indicate their profession, in order to appropriately limit the search. Optionally, the user's profession may be obtained from, e.g., the user's profile.

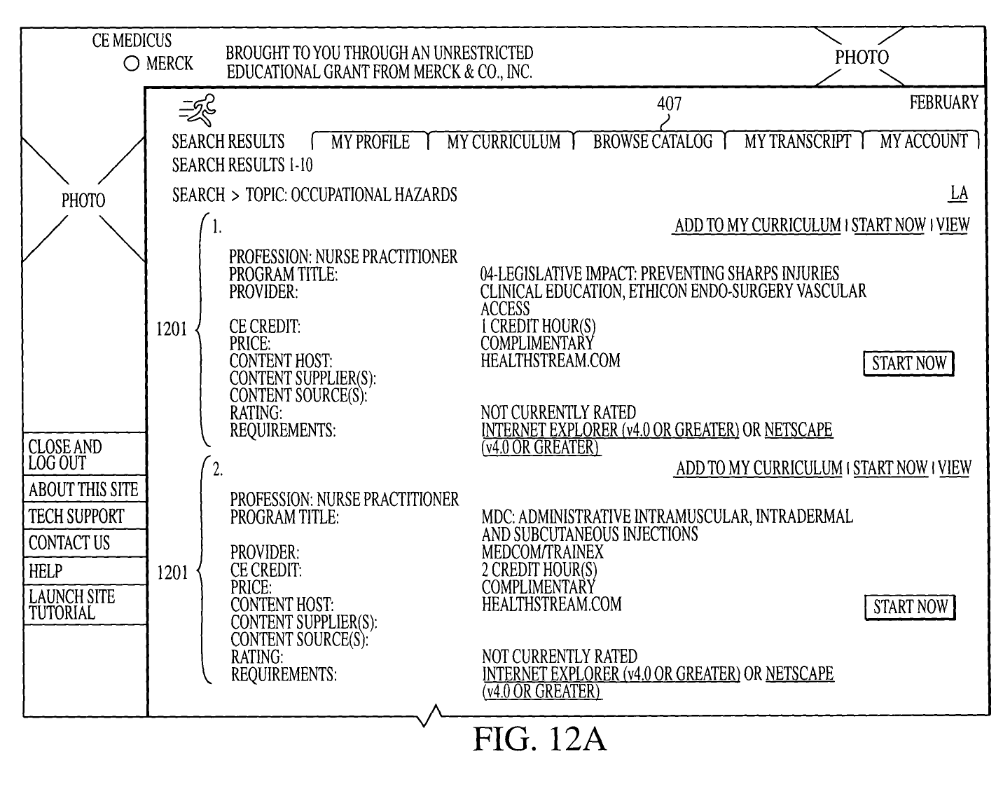

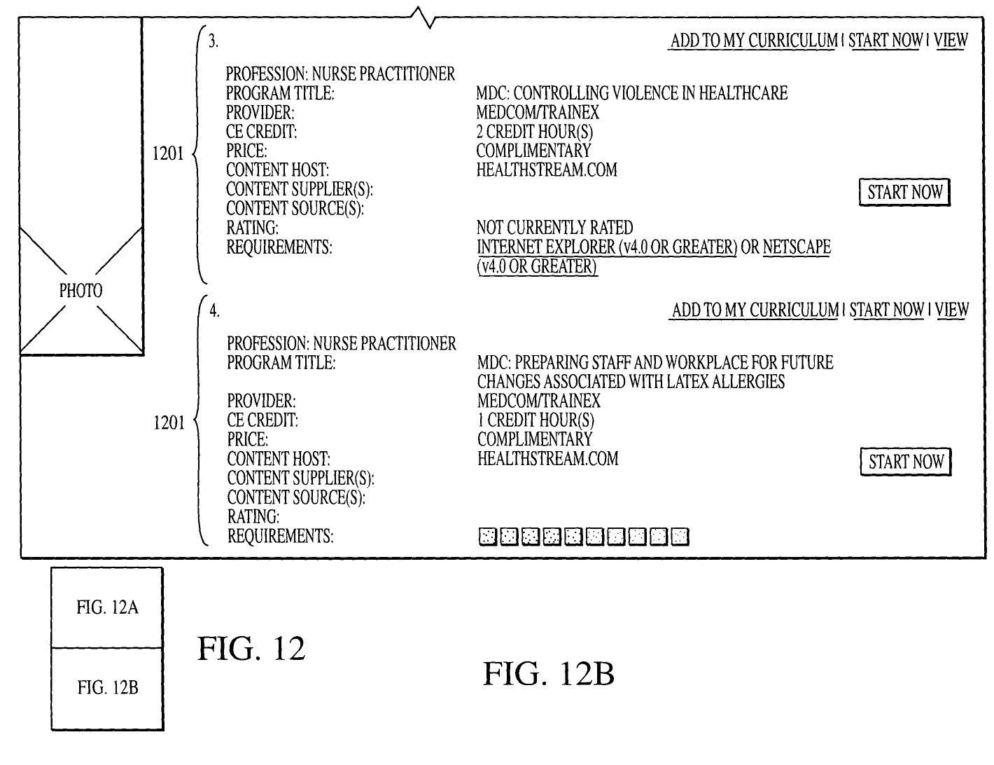

After completing a search, the search results will be displayed, as for example in FIG. 12, with detailed information about the CE activities 1201. The information may include, for example, one or more of the following: a title, target profession, CE provider, price, a brief description of the CE activity, a total number of credit hours and professional accreditation that is available, and/or system requirements and access thereto to properly view the content. Optionally, the CE description may include a user rating to indicate how peers rated the activity, e.g., by anonymous evaluations. In the illustrated example, the user may add one or more CE activities from the search results to their curriculum. Selecting an activity and indicating that it should be added to the curriculum will then add the CE activity to the user's curriculum. Optionally, selecting the activity to be added to the curriculum will return the user to the curriculum manager, where the user may launch the activity if desired.

If the user's search locates an activity already included in the user's curriculum, optionally the system may allow them to launch the activity, according to one or more embodiments of the present invention. Many of the CE activities may be returned as search results and/or accessed even subsequent to the user's commencement or completion of the CE activity. If the user has located a CE activity during the search which is previously completed, optionally the system provides that the user may re-enter the activity, for example in a non-credit or view-only mode.

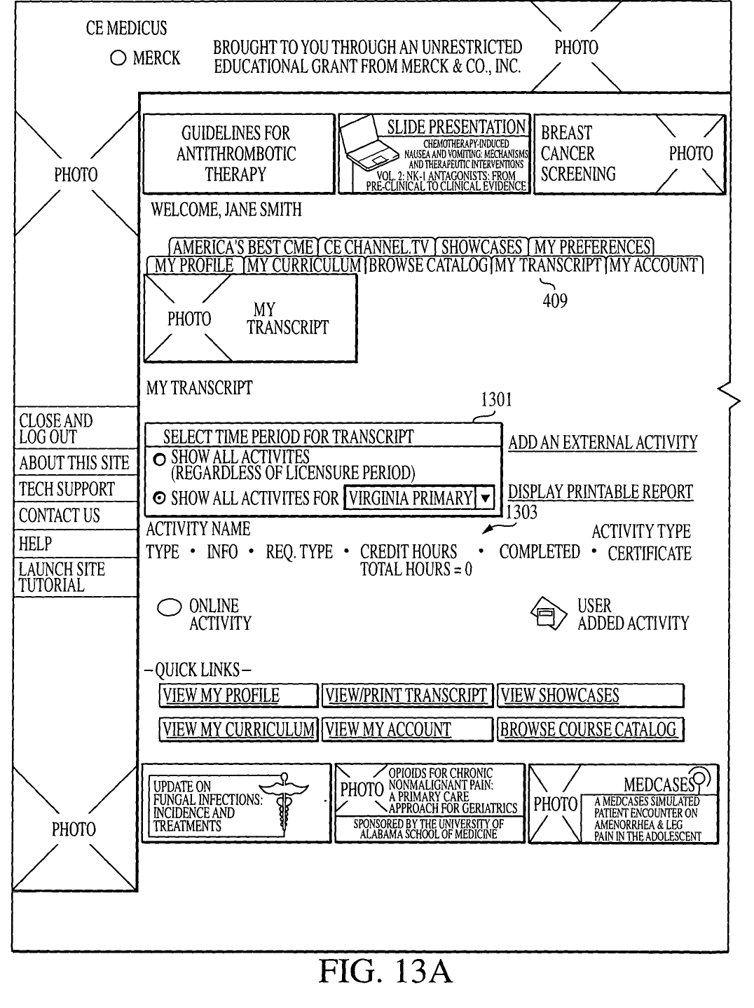

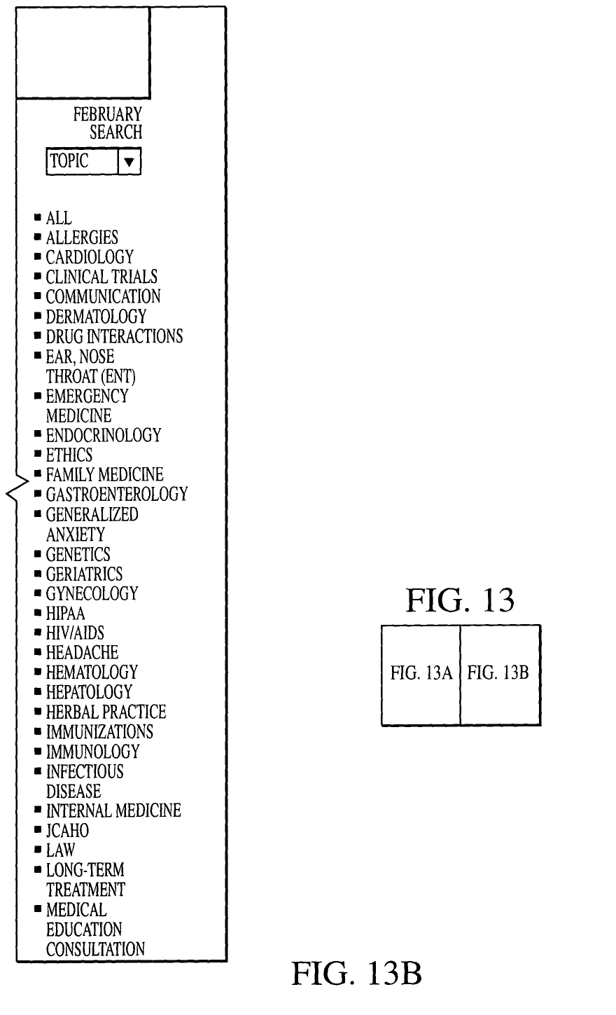

Reference is now made to FIG. 13, illustrating one example of a user interface for a personal transcript manager 409. The transcript manager provides a convenient way for the user to track their completed on-line activities in one central location. The user may select 1301 the time period and/or licensure jurisdictions to be included in the transcript. An activity summary 1303 of the activities to be included in the transcript may be provided. Optionally, activities completed off-line or completed externally to the system may be entered into the transcript. This will allow the user to build a more complete digital record of their CE activities. Optionally, CE activities completed on-line may be automatically updated into the user's transcript.

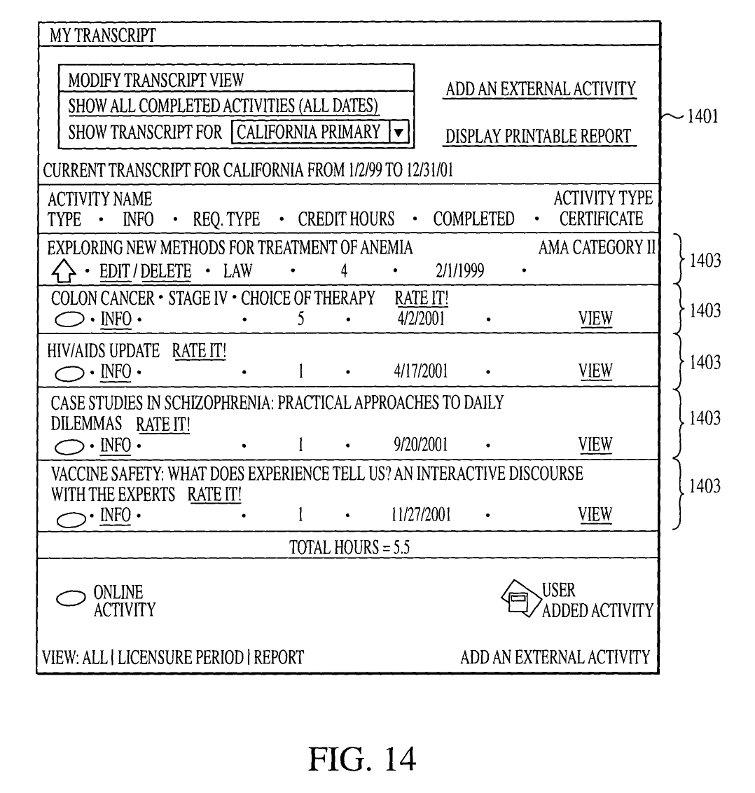

Reference is made to FIG. 14, illustrating one example of a transcript summary. By default, the interactive CE system optionally displays only those activities completed during the user's current licensure. The user may view all of the activities stored in the transcript, by an appropriate command. If the user has set up their account to track more than one licensure jurisdiction, they optionally may select the jurisdiction, such as from a dropdown menu, in order to view CE activities completed for that state's licensure period. A transcript table 1401, illustrated in FIG. 14, may display information about each completed CE activity 1403. Optionally, the transcript table 1401 may display information added regarding external CE activities. Optionally, CE activities that were successfully completed on-line via the system are automatically updated into the user's transcript. One or more of the CE activities that were completed by the user may be able to reprint duplicate certificates. If this is possible, the system optionally will allow the user to print their duplicate certificate. Optionally, certificates earned through educational activities other than those completed on-line through the system, such as a paper-based home study, grand rounds or live seminars, may be added to the user's transcript. Instructing the system to add an external activity will present the user with an appropriate form and the external CE activity will be added to the user's current transcript. Additionally, the user may edit or delete external activity information if preferred.

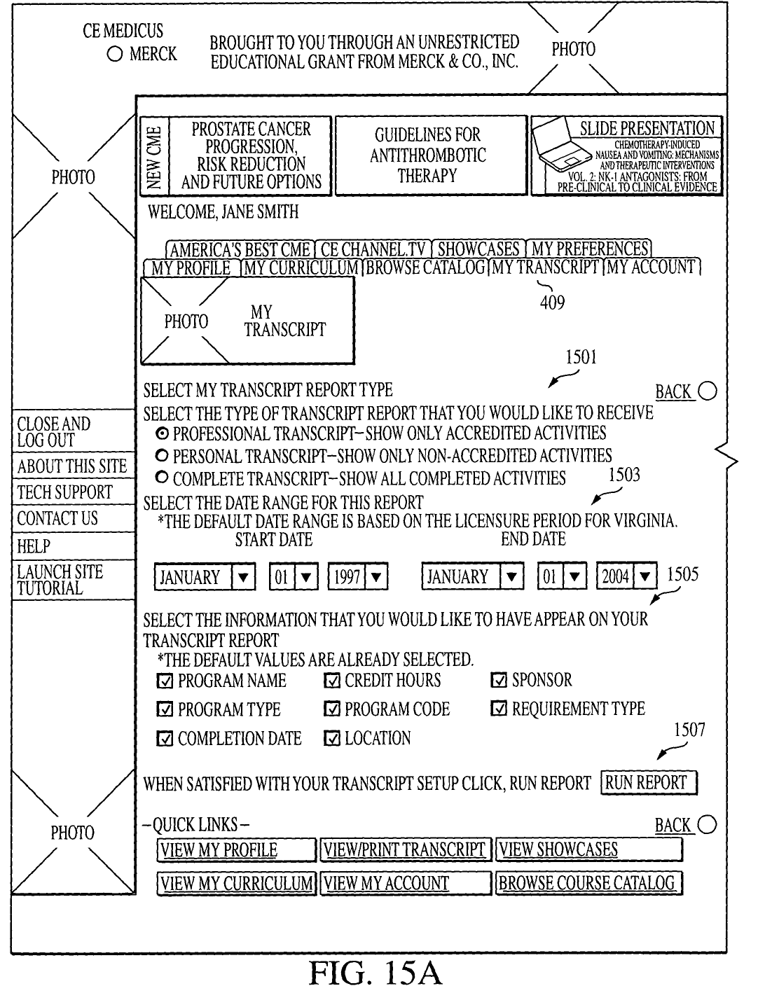

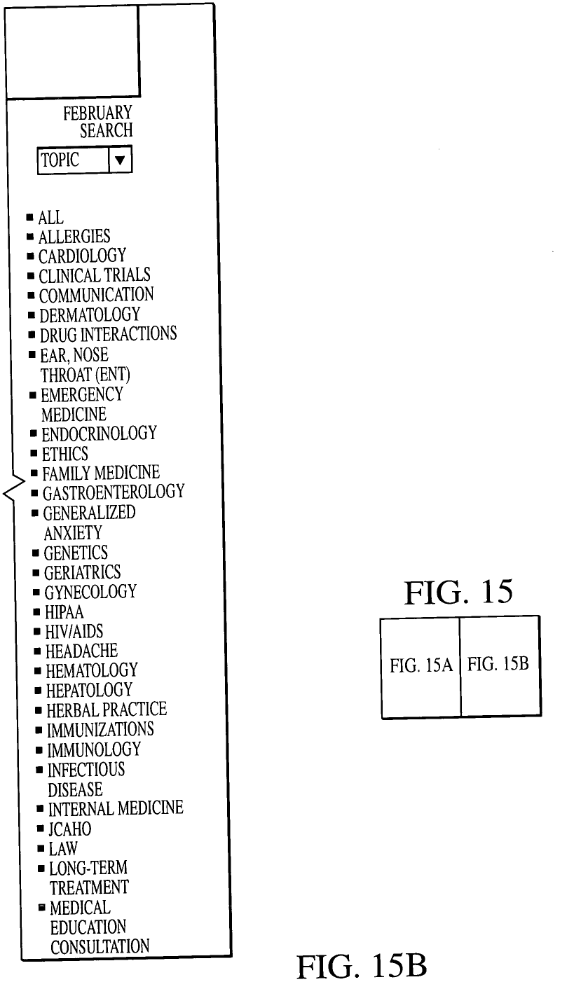

Reference is made to FIG. 15, illustrating the optional transcript report generator. A report generator may be provided that allows a user to customize, review and/or print a professional transcript. The report generator allows a user to customize their transcript report. The user may select the transcript report type 1501, the date range 1503, and/or the information that is to appear on the transcript 1505. When satisfied with the transcript setup, the user may generate 1507 a printer-ready version of their transcript.

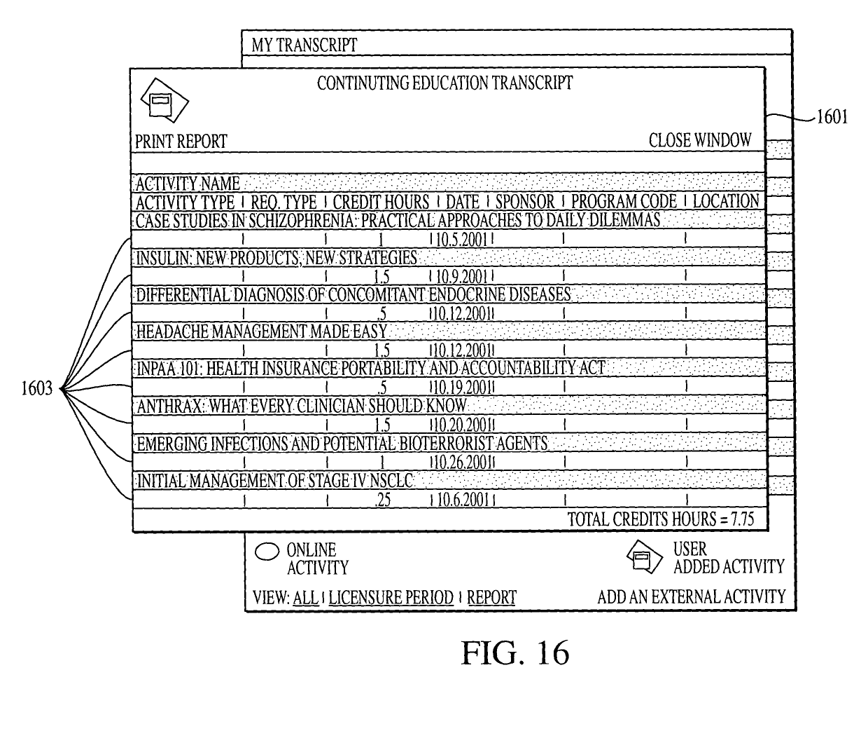

FIG. 16 illustrates a transcript report 1601, including several CE activities 1603. In this example, the transcript report 1601 is appropriate for printing, or for being electronically transmitted.

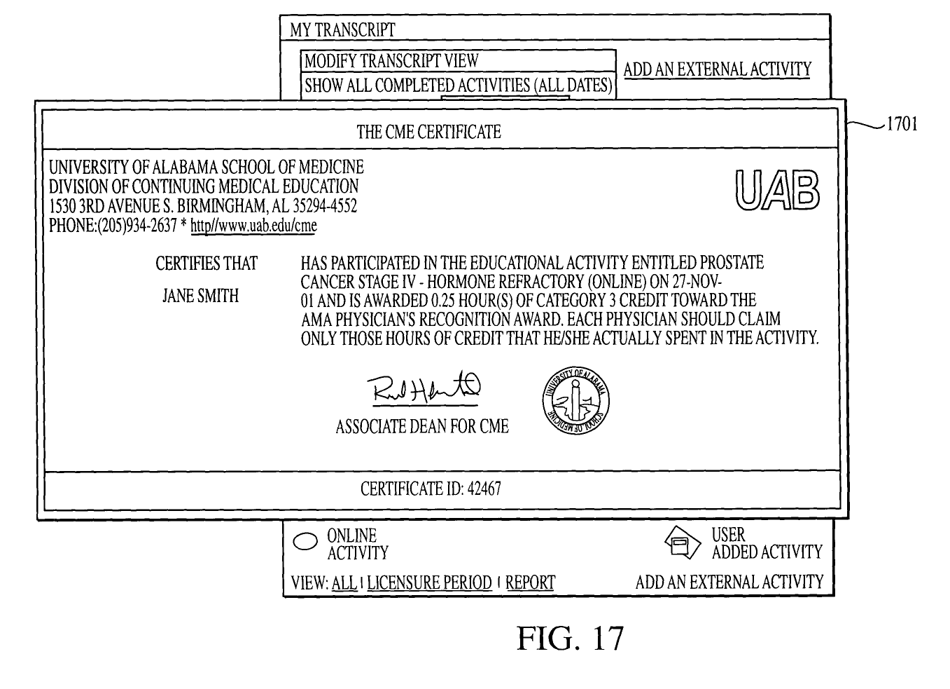

Reference is made to FIG. 17, illustrating a CE certificate 1701 for an external CE activity that was added to the user's current transcript from a digital source. In this example, the CE certificate 1701 is appropriate for printing.

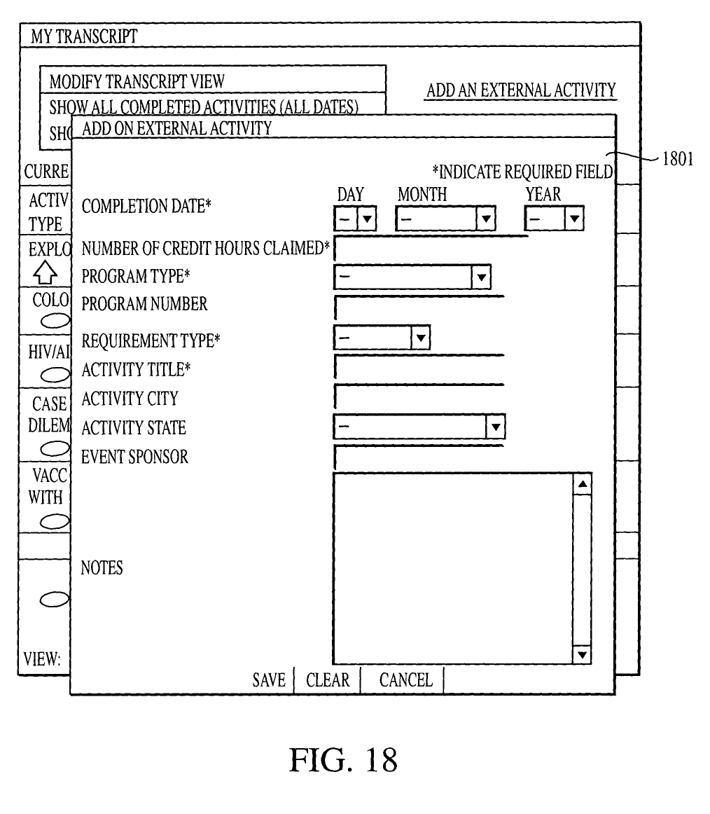

FIG. 18 illustrates one example of a user interface for collecting information regarding an external CE activity 1801, to be added to the user's curriculum. The system interacts with the user to obtain information regarding the external CE activity. Optionally, the system may access the information if provided electronically by the CE provider. Optionally, the user may store a copy of the certificated for the external CE activity.

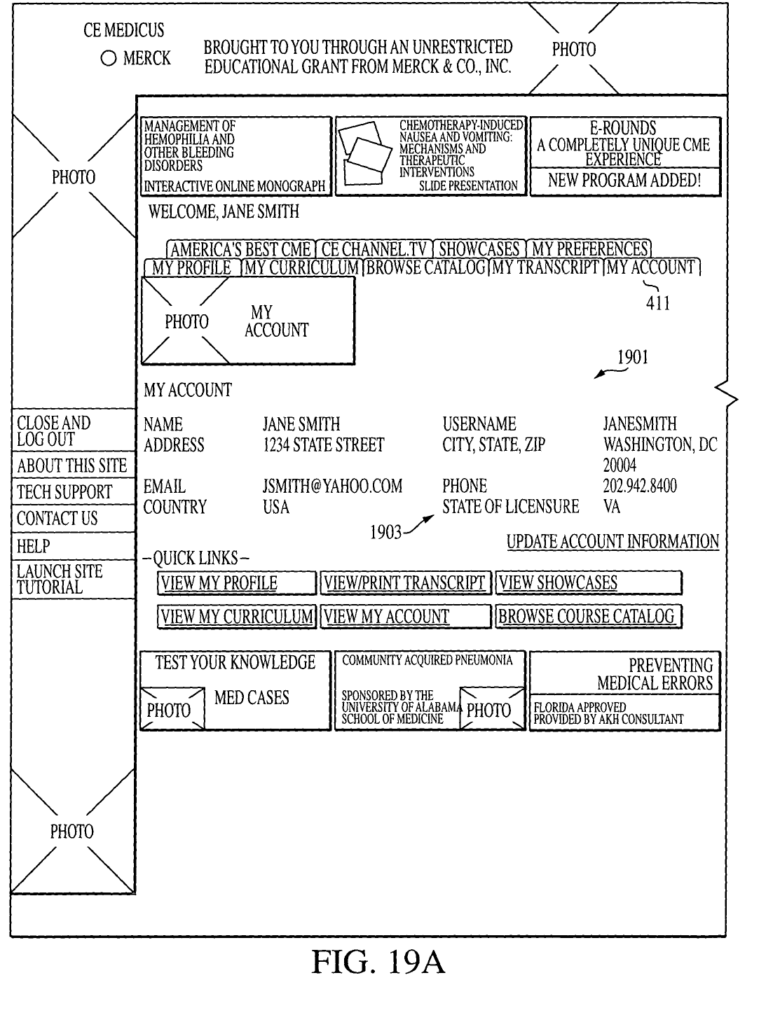

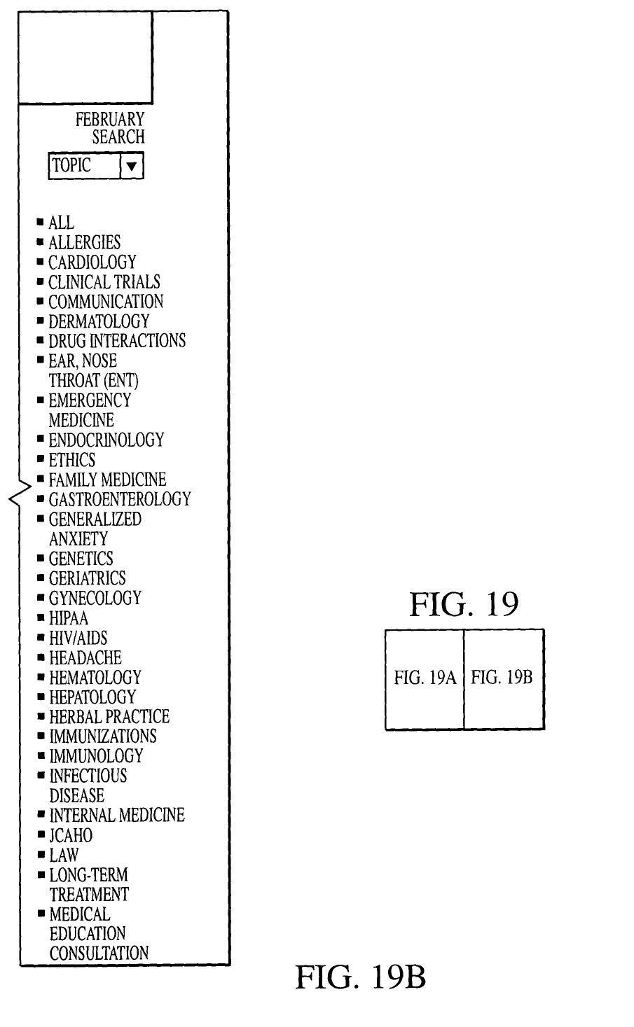

Reference is now made to FIG. 19, illustrating an exemplary user interface for one embodiment of the account manager, for use in connection with the present invention. The account manager 411 allows the user to view their personal information in their account that was entered during registration. The information includes contact information 1901, e.g., name, address, phone, email; as well as licensure information 1903. A user may modify this information, for example by selecting and modifying the information. (Optionally, certain information might not be modifiable, e.g. username.) Changes to this information may be saved to the user's account.

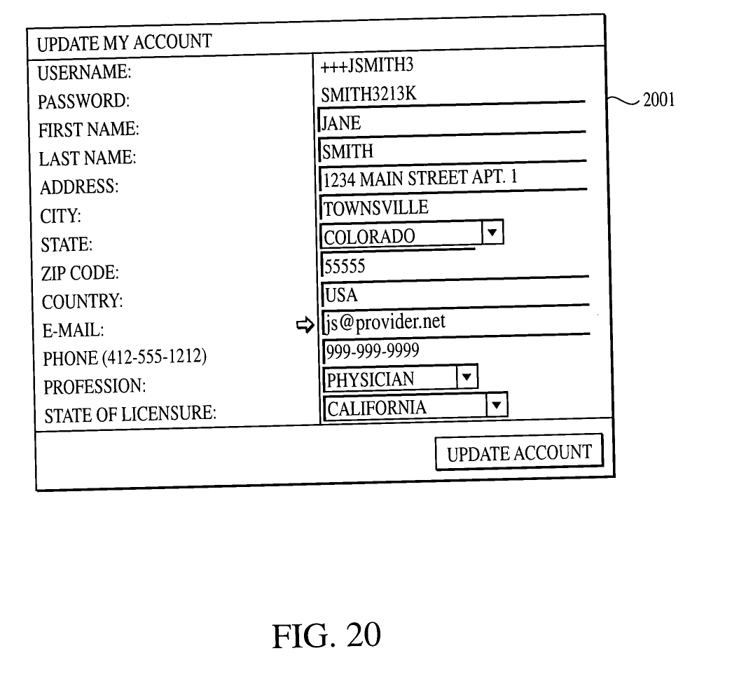

Reference is made to FIG. 20, illustrating one example of a menu for interacting with the user in order to update the user's account. This menu 2001 prompts the user for information that can be changed. The user may cause their account to be updated. The next time the user enters the interactive CE system, they will note that the changes have been made.

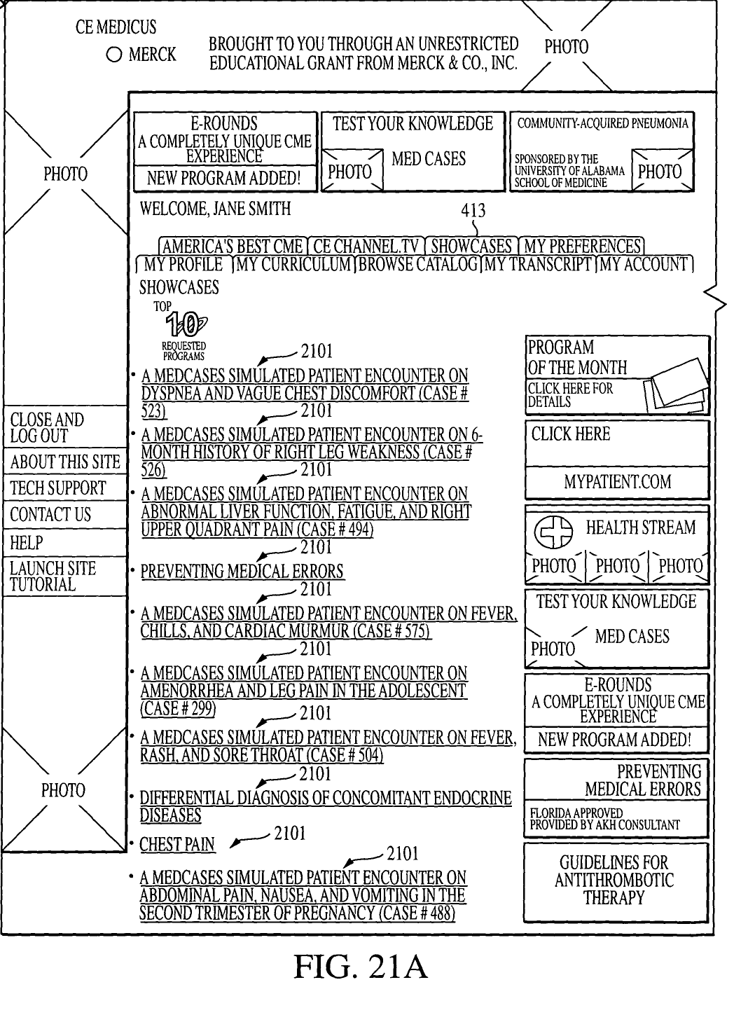

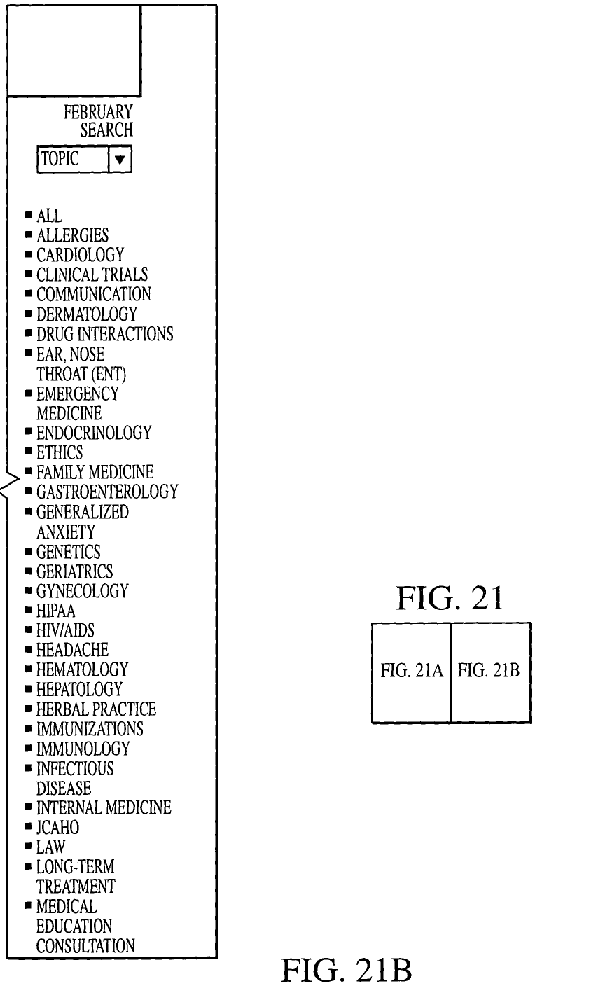

Reference is now made to FIG. 21, illustrating one example of the optional showcases section 413. The showcases section displays a selection of showcased CE activities and/or libraries within the interactive CE system. Each of the showcased CE activities 2101 is displayed, for example in summary. The showcase may determine to showcase, e.g., select the top 10 most requested programs. Instead of 10 programs, the system could display more or fewer selected showcase programs. Alternatively, the system may determine which CE activities to showcase by any appropriate manner, including, e.g., most selected, most frequently completed, most frequently reviewed, most recent additions to the catalog, and/or may be limited to the user's areas of interest. The method for selecting the showcased programs may be indicated to the user. The user may access any one of these activities from the showcase list. For example, they may select a title to add the activity to the user's curriculum and/or launch into the new activity.

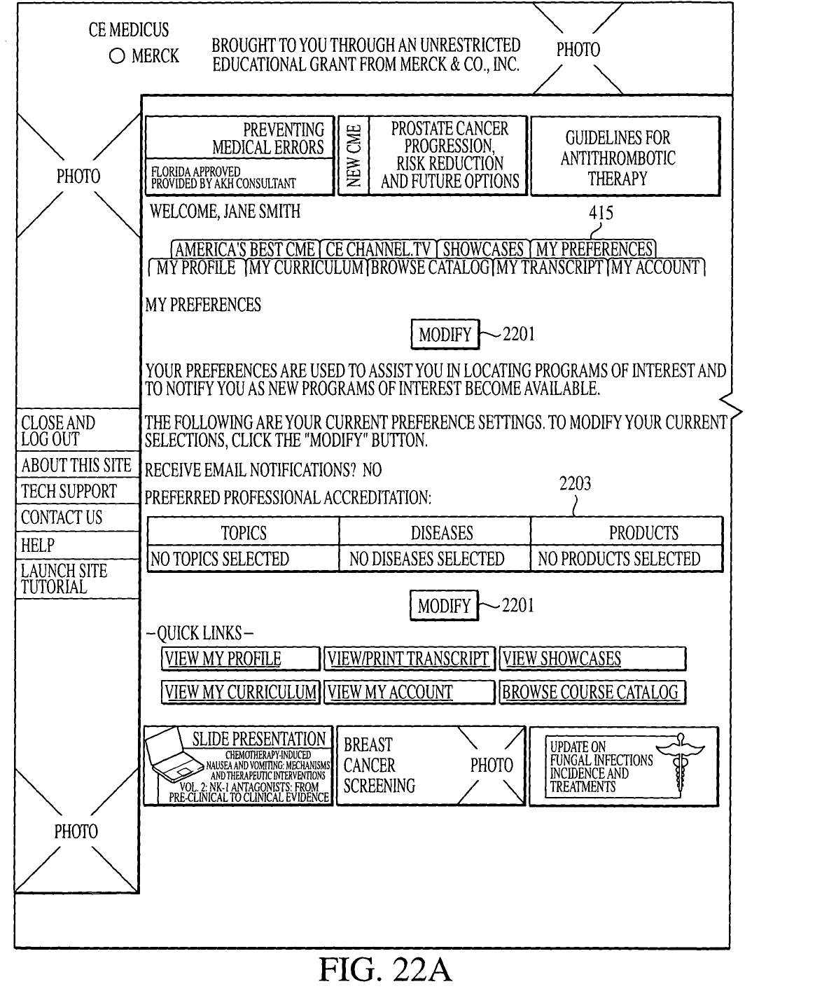

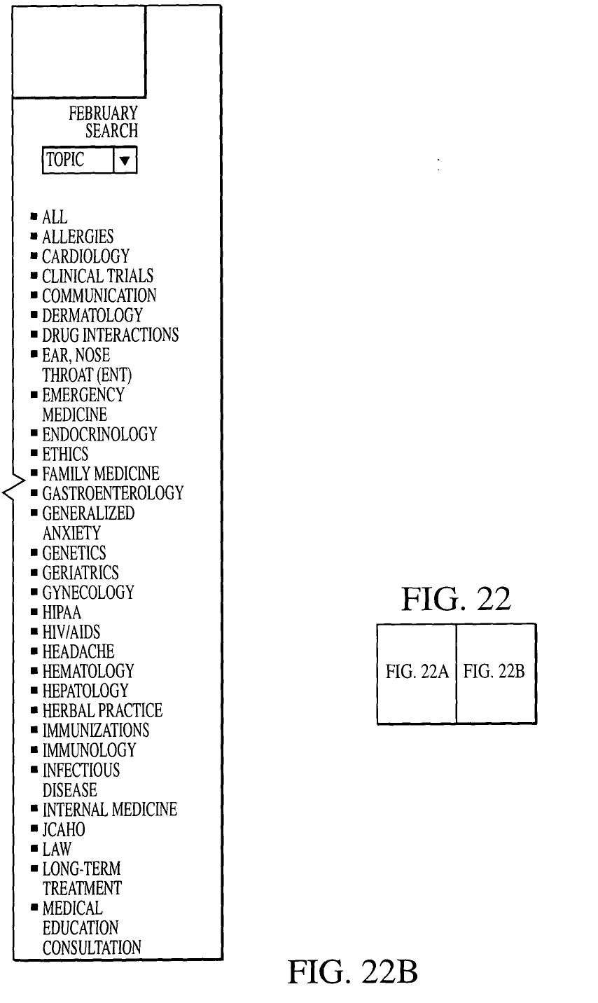

Reference is now made to FIG. 22, illustrating one example of the preference manager 415. When the user initially logs in to the interactive CE system, they may create a set of preferences 2203 for their account, intended to indicate the user's fields of interest. The preferences 2203 may include, for example, preferred professional accreditation, topics, diseases, and/or products. The preference manager optionally may include a continuing education assistant feature. This assistant feature reviews the user's preferences to determine when to alert the user as new activities of interest are added to the catalog. The assistant feature may, for example, run in the background; as new activities are added to the catalog that match the selected preferences, the assistant will automatically notify the user of the activities, such as via email. The user may modify 2001 their preferences, and/or may opt out of receiving notification from the assistant.

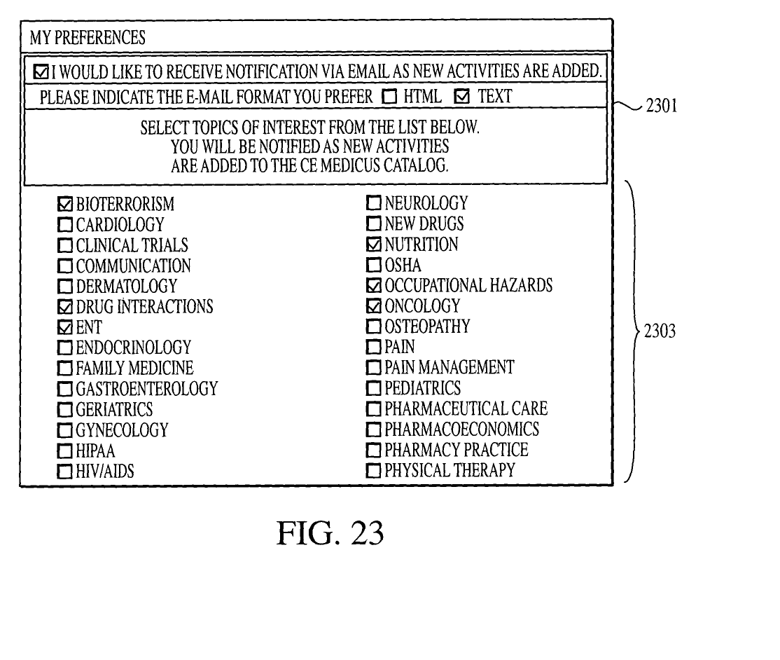

Reference is made to FIG. 23, illustrating an example of a menu 2301 for selecting topics 2203 of interest for the continuing education assistant.

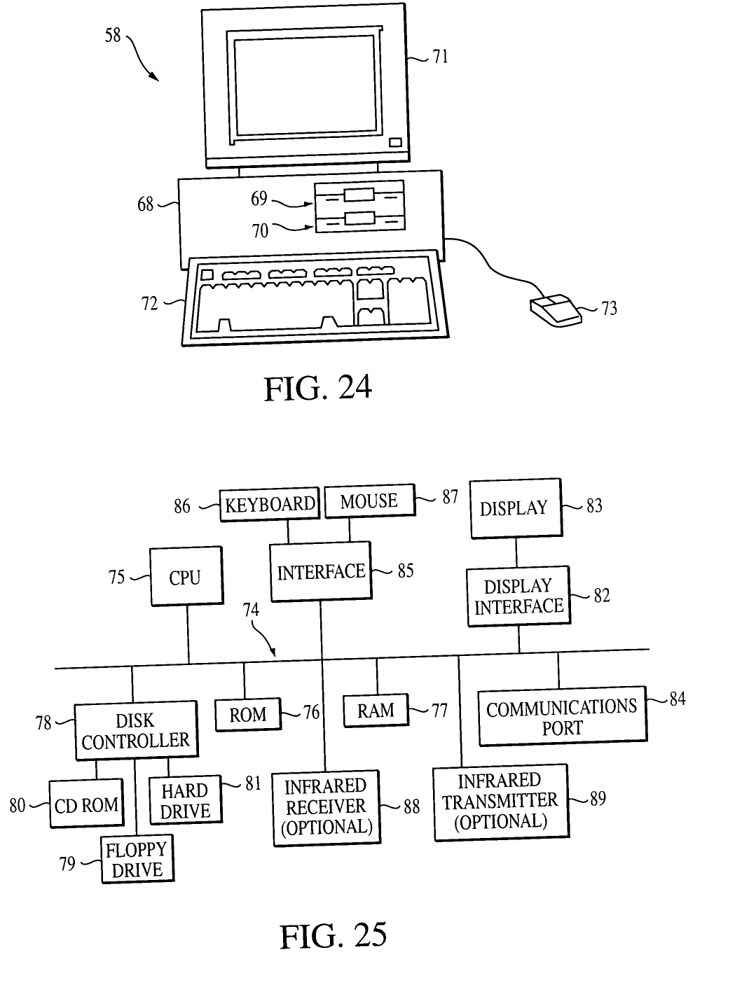

FIG. 24 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 24, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

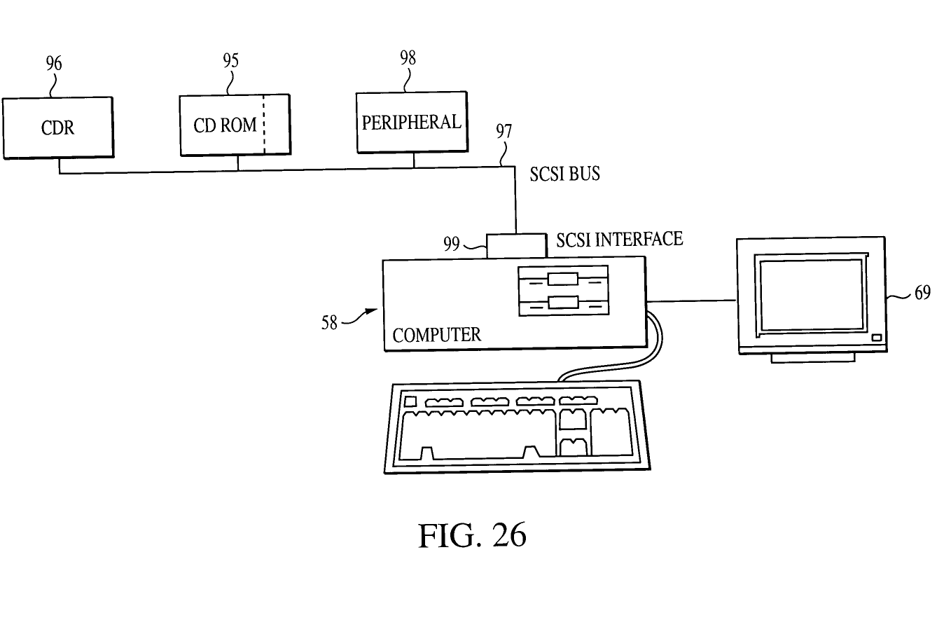

Alternatively, referring to FIG. 26, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

FIG. 25 illustrates a block diagram of the internal hardware of the computer of FIG. 24. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

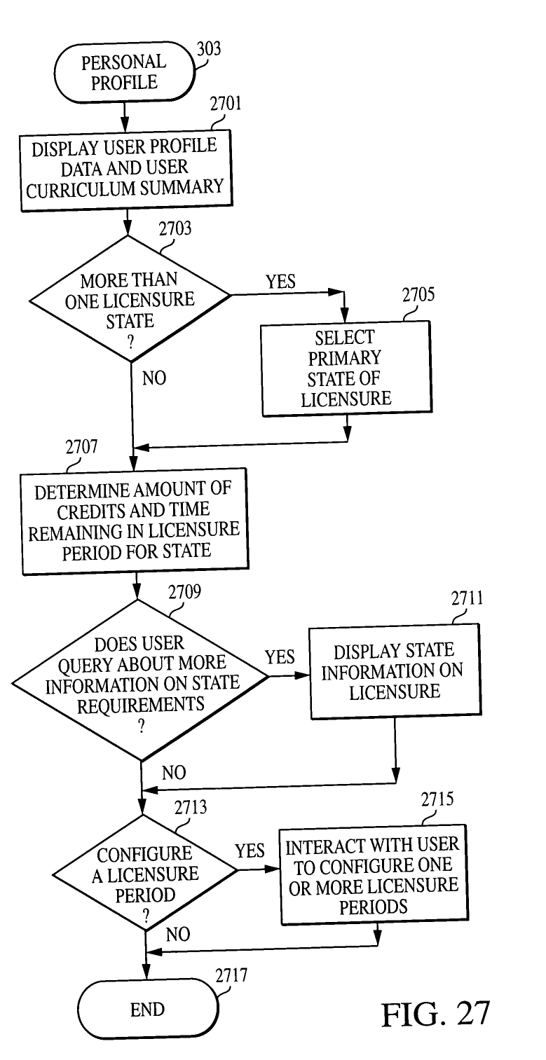

Reference is now made to FIG. 27, illustrating an example flowchart for one or more embodiments of the personal profile 303. In this example, the system displays the user profile data and the user curriculum summary at Step 2701. At Step 2703, if there is more than one licensure state for this user, the system selects the primary state of licensure at Step 2705. At Step 2707, the system determines the amounts of credits and time remaining in the licensure period for the particular state. At Step 2709, the system determines whether the user queries about additional information for state requirements. If so, then at block 2711, the system displays state information on licensure. At block 2713 the system queries whether the user wishes to configure a licensure period. If so, the system then interacts with the user to configure one or more licensure periods, at block 2715. At block 2717, the personal profile ends.

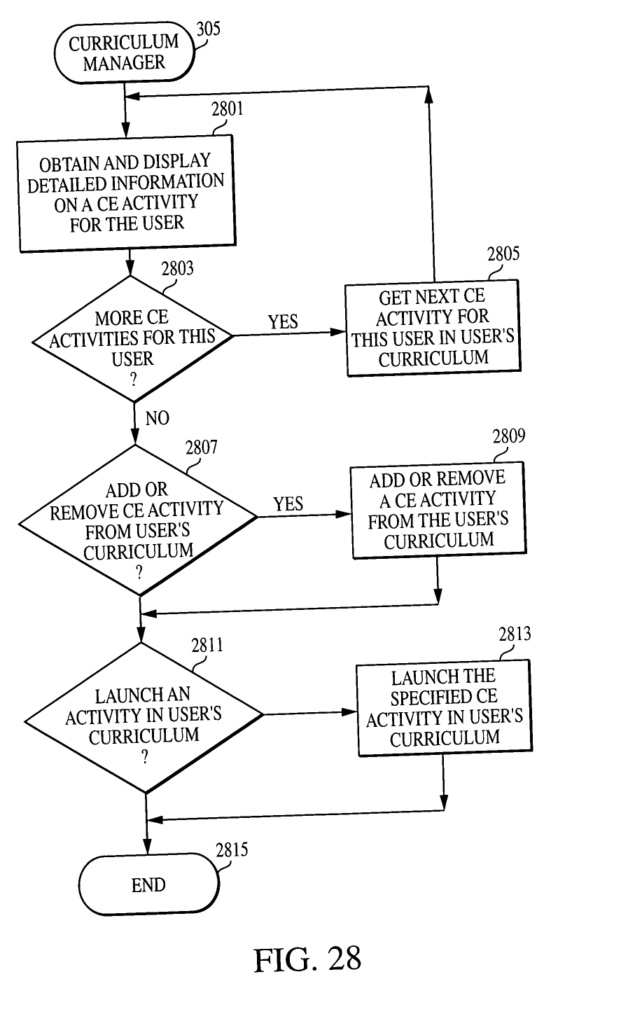

Reference is now made to FIG. 28, illustrating one example of a flowchart for one or more embodiments of the curriculum manager 305. The system obtains and displays detailed information on a CE activity in the curriculum of present user, at block 2801. At block 2803, the system determines whether there are additional CE activities for this user. If so, the system gets the next CE activity for this user in the user's curriculum, at block 2805, and loops back to block 2801. Otherwise, the system queries whether the user wishes to add or remove a CE activity from the user's curriculum at block 2807. If so, the system interacts with the user in order to add or remove a CE activity from the user's curriculum at block 2809. The system then queries the user whether they wish to launch an activity in the user's curriculum at block 2811. If so, the system then launches the specified CE activity in the user's curriculum at block 2813. The curriculum manager then ends at block 2815.

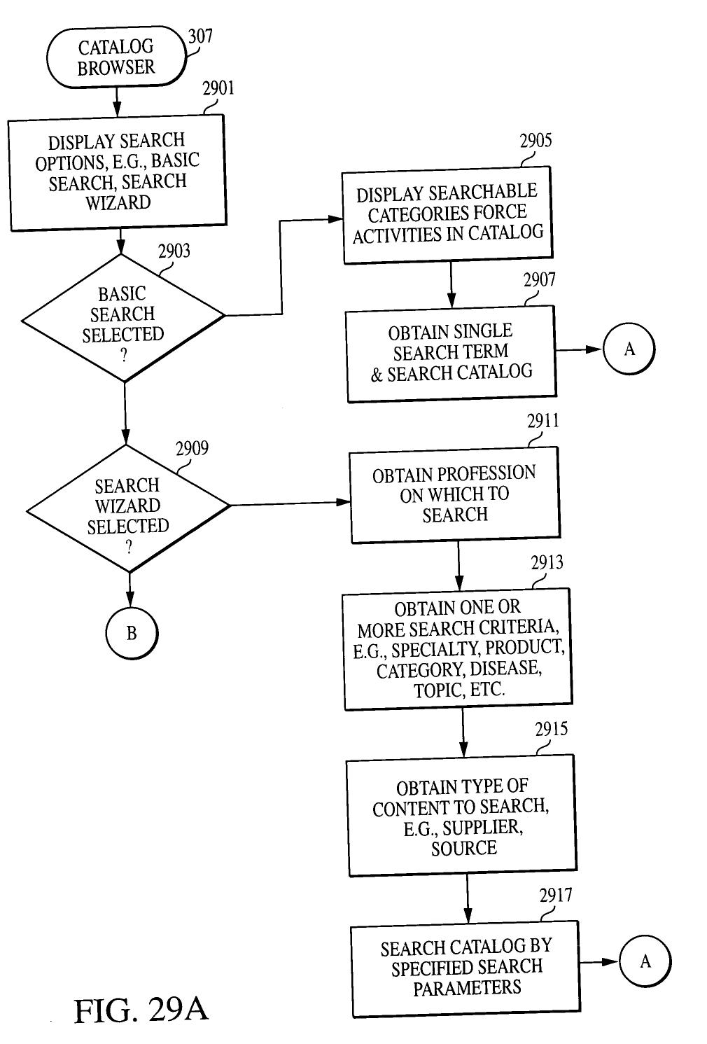

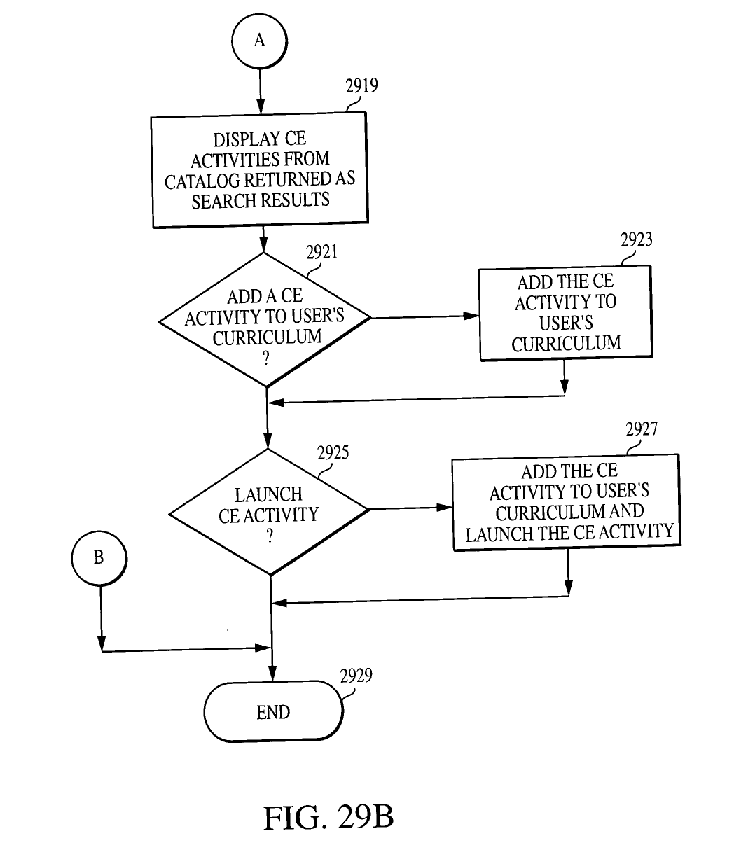

Reference is now made to FIGS. 29A-29B, illustrating an example flowchart for one or more embodiments of the catalog browser 307. When the user selects the catalog browser, at block 2901 the system displays search options, for example, the basic search and the search wizard. At block 2903 the system determines whether the user selected the basic search. If so, the system then displays the searchable categories for activities in the catalog block 2905. At block 2907, the system obtains a single search term and searches the catalog. If the basic search is not selected, the system determines whether the search wizard is selected at block 2909. If so, the system obtains the profession on which to search at block 2911. According to this example, the profession is a required search term for the wizard, however, other search terms could be required and/or optional. At block 2913, the system obtains one or more search criteria, including, for example, specialty, product, category, disease, topic, etc. At block 2915, the system obtains the type of content to search, for example, supplier, source. The type of content is optional. At block 2917, the system searches the CE catalog by the specified search parameters. Having obtained the search results for either the basic search or the search wizard, the system displays the CE activities from the catalog which were returned as search results 2919. At block 2921, the system inquires whether the user wishes to add a CE activity to the user's curriculum. If so, at block 2923, the system adds the CE activity to the user's curriculum. The system inquires whether the user wishes to launch a CE activity at block 2925. If so, the system adds the CE activity to the user's curriculum and launches the CE activity 2927. A CE activity may be launched by commencing the activity as a separate process with the user. At block 2929, the catalog browser exits.

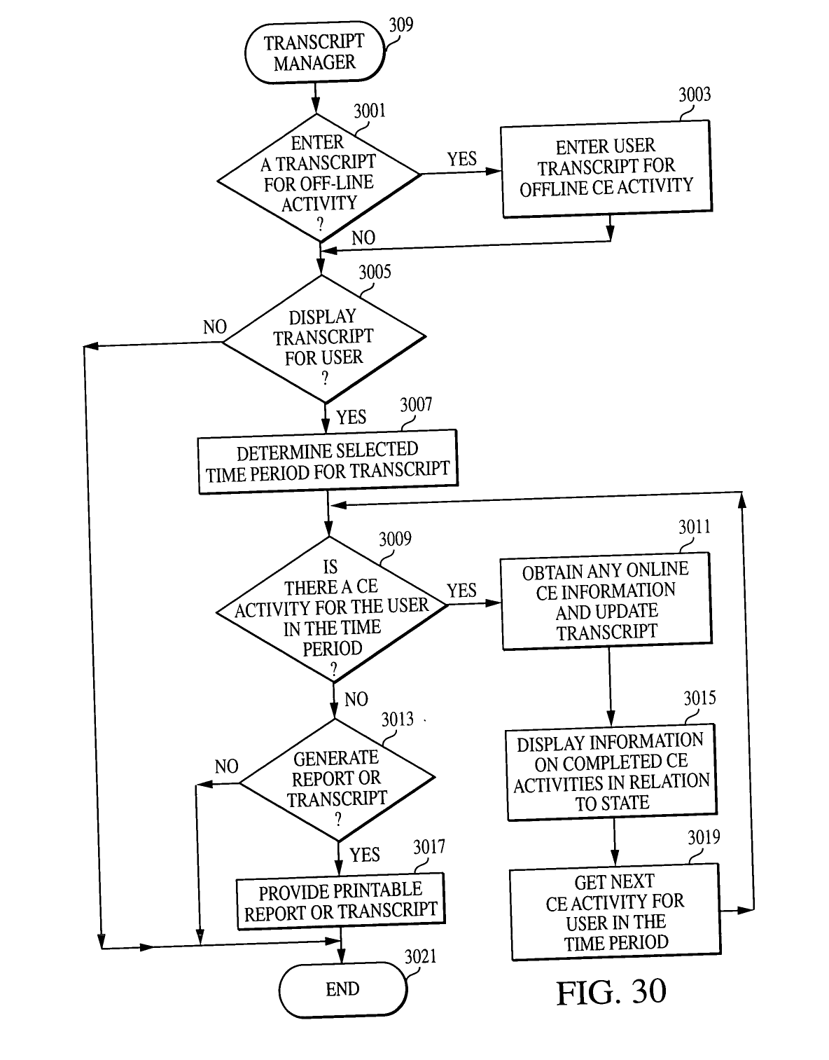

Reference is now made to FIG. 30, illustrating an example flowchart for one or more embodiments of the transcript manager 309. The system queries whether the user wishes to enter a transcript entry for an off-line activity at block 3001. If so, the system prompts the user in order to enter the transcript data for the off-line CE activity at block 3003. The system then determines whether the user wishes to display a transcript at block 3005. If not, the system then ends at block 3021. On the other hand, if so, the system determines the selected time period for the transcript at block 3007.

Then if there is a CE activity for the user in the time period, at block 3009, the system obtains any on-line CE information and updates the transcript at block 3011. At block 3015, the system displays the information on completed CE activities in relation to the state requirements. At block 3019, the system obtains the next CE activity for the user in the specified time period, and loops back to block 3009. If there is no further CE activity in the time period, the system determines whether or not to generate the report or the transcript by interacting with the user, at block 3013. If the report or transcript is to be generated, then at block 3017, the system provides a printable report or transcript. At block 3021, the transcript manager ends.

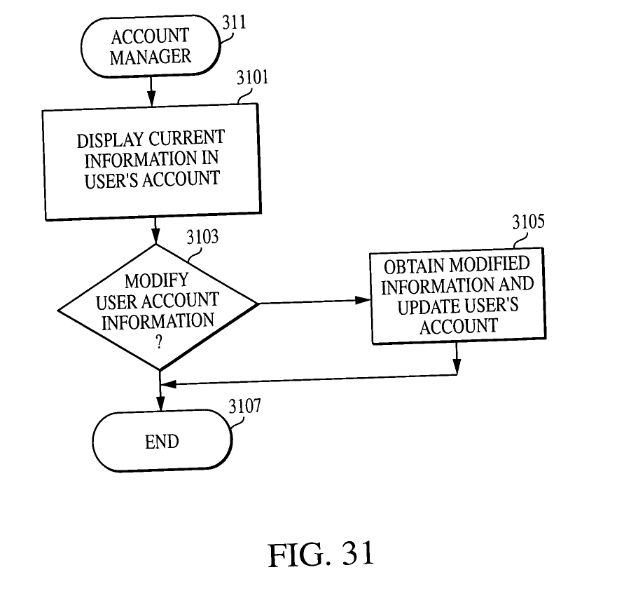

Reference is now made to FIG. 31, illustrating an example flowchart for one embodiment of the account manager 311. At block 3101, the system displays the current information in the user's account. At block 3013, the system determines whether the user wishes to modify their account information. If so, the system obtains modified information and updates the user's account at block 3105. At block 3107, the account manager ends.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the interactive CE system may include a general purpose computer, or a specially programmed special purpose computer. The user may interact with the interactive CE system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The interactive CE system used in connection with the invention may rely on the integration of various components including, as appropriate and/or if desired, hardware and software servers, database engines, and/or CE content providers. The configuration may be, preferably, network-based and uses the Internet as a primary interface with the user.

The CE system may store collected information and/or indexes to information in a database. An appropriate database may be on a standard server, for example, a small Sun™ Sparc™ or other remote location. The information may, for example, optionally be stored on a platform which may, for example, be UNIX-based. The various databases maybe in, for example, a UNIX format, but other standard data formats may be used.

Although the computer system in FIG. 3 is illustrated as having a single computer, the interactive CE system is optionally suitably equipped with a multitude or combination of processors or storage devices. For example, the computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently, available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

The many features and advantages of the embodiments of the present invention are apparent from the detail specification, and thus, it is intended by the appended claims to cover all such features and advantages of the invention which fall within the true spirit and scope of the invention. Further, since numerous modifications and variations were readily occurred to those skilled in the art, it is not desired to limit the invention to the exact construction and operation illustrated and described, and accordingly, all suitable modifications and equivalents maybe resorted to, falling within the scope of the invention.

What is claimed is:

1. In a computer-based system for managing and/or providing continuing healthcare education (CE) activities, an interactive CE system for users including physicians and healthcare providers, implemented by a computer system, said interactive CE system comprising:
(A) a personal profile, providing information representative of a user's educational progress characterized by one or more CE activities in a curriculum of the user, against licensure requirements for one or more jurisdictions selected by the user;
(B) a curriculum manager, providing information representative of the current CE activities in the curriculum of the user;
(C) a catalog browser search engine, searching a catalog of CE activities to locate CE activities of interest for the user; and
(D) a personal transcript manager, tracking completed online CE activities of the user in a transcript for the user.

2. The system of claim 1, wherein the information representative of the user's educational progress is further characterized by a time remaining in a licensure period for the selected one or more jurisdictions.

3. The system of claim 1, wherein the personal profile further includes at least one of: providing data indicative of at least one CE activity in the user's curriculum; adding at least one CE activity to the user's curriculum; listing one or more CE activities that are open in the user's curriculum; providing information about CE requirements for one or more specified jurisdictions; providing information about the one or more open CE activities and a status of the user's progress in the open CE activities; and configuring the one or more licensure periods for the user for at least one of the jurisdictions.

4. The system of claim 1, wherein the information provided by the curriculum manager representative of each of the current CE activities further includes, for each CE activity, at least one of: a status of the CE activity and the user's completion thereof, a number of credit hours for the CE activity, date of last access of the CE activity by the user, and an indication of whether the CE activity has been submitted for credit.

5. The system of claim 1, wherein the curriculum manager further at least one of adds and removes at least one CE activity in the user's curriculum.

6. The system of claim 1, wherein the curriculum manager launches one or more CE activities in the user's curriculum.

7. The system of claim 1, wherein the catalog browser search engine includes a search locating activities based on single, user-defined categories available within the catalog.

8. The system of claim 1, wherein the catalog browser search engine includes a search wizard searching by one or more of: profession, topic, product category, condition, disease, disorder, keyword, and phrase.

9. The system of claim 1, wherein the catalog browser search engine further includes a display screen having information about the located at least one CE activity, the information including one or more of: brief description, the number of credit hours, professional accreditation, prior user ratings; a first means for adding an activity to the user's curriculum; and a second means for launching a selected one of the CE activities and adding the selected one of the CE activities to the user's curriculum.

10. The system of claim 1, wherein the personal transcript manager further tracks online CE activities and offline CE activities.

11. The system of claim 10, wherein the offline CE activities are tracked by allowing transcript data to be entered for the offline CE activities; and wherein the online CE activities are tracked by accessing online CE information to automatically update transcript data.

12. The system of claim 1, wherein the personal transcript manager further displays CE activities completed by the user in relation to at least one of jurisdiction and period of licensure.

13. The system of claim 1, wherein the personal transcript manager reprints a certificate for CE earned by the user; and to at least one of generates and customizes at least one of the transcripts and a report showing at least one of accredited CE activities, non-accredited CE activities, and completed CE activities, in the user's transcript.

14. The system of claim 1, further comprising an account manager allowing a user to at least one of view and change account information in the user's account, including modifying contact information, personal information, one or more jurisdictions of licensure, and profession.

15. The system of claim 1, further comprising a showcase system displaying information concerning at least one of selected CE activities and selected libraries in the interactive CE system, including shortcuts to locate the selected CE activities and the selected libraries; adding one of the selected CE activities to the user's curriculum; and launching the one of the selected CE activities.

16. The system of claim 1, further comprising a preference manager, determining to alert the user if at least one activity of interest is added to the catalog.

17. The system of claim 16, wherein the preference manager further includes at least one of creating and editing a set of user preferences including at least one user preference, and notifying the user of one or more CE activities added to the catalog and which match the at least one user preference.

18. In a computer-based system for managing and/or providing continuing healthcare education (CE) activities, an interactive CE system for users including physicians and healthcare providers, implemented by a computer system, said interactive CE system comprising:
(A) a personal profile, providing data indicative of at least one CE activity in a user's curriculum and adding or more CE activities to the user's curriculum, including listing one or more CE activities open in the user's curriculum; providing information representative of a user's educational progress characterized by the open CE activities in the user's curriculum against a time remaining in a licensure period for one or more jurisdictions indicated by the user; providing information about CE requirements for one or more specified jurisdictions; providing information about the open one or more CE activities open in the user's curriculum and a status of the user's progress in the CE activities; and configuring the licensure period for one or more jurisdictions indicated by the user;
(B) a curriculum manager, providing information representative of the open one or more CE activities, including status, number of credit hours, a date of last access by the user, an indication of whether the CE activities have been submitted for credit; at least one of adding and removing one or more CE activities in the user's curriculum; and launching one or more CE activities in the user's curriculum;
(C) a catalog browser search engine searching a catalog of a plurality of CE activities to locate activities of interest to the user, including at least one of: a search locating CE activities in the catalog based on a single, user-defined categories available within the catalog; and a search wizard searching for CE activities in the catalog by one or more of: profession, topic, product category, condition, disease, disorder, keyword, and phrase; a display screen having information for each located CE activity including one or more of: brief description, a number of credit hours, professional accreditation, and prior user ratings; a first means for adding a selected one of the located CE activities to the user's curriculum; and a second means for launching a selected one of the located CE activities and adding the selected one of the located CE activities to the user's curriculum;
(D) a personal transcript manager tracking, in a transcript for the user, at least one of completed online CE activities and offline CE activities, including allowing the user to enter a transcript data for the offline CE activities, accessing online CE information to automatically update the user's transcript; displaying completed CE activities in the user's transcript in relation to at least one of jurisdiction and period of licensure; reprinting certificates for CE activities earned by the user; and to at least one of generate and customize at least one of the transcripts and a report showing at least one of accredited CE activities, non-accredited CE activities, and completed CE activities, in the user's transcript;
(E) an account manager allowing a user to at least one of view and change account information in the user's account, including modifying contact information, personal information, one or more jurisdictions of licensure, and profession;
(F) a showcase system displaying information concerning at least one of selected CE activities and selected libraries in the interactive CE system, including shortcuts to locate the selected CE activities and the selected libraries; adding one of the selected CE activities to the user's curriculum; and launching the one of the selected CE activities; and
(G) a preference manager, reviewing at least one user preference and determining when to alert the user as at least one CE activity of interest is added to the catalog, including at least one of creating and editing a set of one or more user preferences including at least one user preference, and notifying the user of one or more CE activities added to the catalog and which match the at least one user preference.

19. A computer-based method for managing and/or providing continuing healthcare education (CE) activities, in an interactive CE method for users including physicians and healthcare providers, implemented by a computer system, said interactive CE method comprising the steps of:
(A) providing, in a personal profile, information representative of a user's educational progress characterized by one or more CE activities in a curriculum of the user, against licensure requirements for one or more jurisdictions selected by the user;
(B) providing, in a curriculum manager, information representative of the current CE activities in the curriculum of the user;
(C) searching, responsive to a user request, via a catalog browser search engine, a catalog of CE activities to locate CE activities of interest for the user; and
(D) tracking, in a personal transcript manager, completed online CE activities of the user in a transcript for the user.

20. The method of claim 19, wherein the information representative of the user's educational progress is further characterized by a time remaining in a licensure period for the selected one or more jurisdictions.

21. The method of claim 19, wherein the step of providing in the personal profile further includes at least one of, responsive to a user request: providing data indicative of at least one CE activity in the user's curriculum; adding at least one CE activity to the user's curriculum; listing one or more CE activities that are open in the user's curriculum; providing information about CE requirements for one or more specified jurisdictions; providing information about the one or more open CE activities and a status of the user's progress in the open CE activities; and configuring the one or more licensure periods for the user for at least one of the jurisdictions.

22. The method of claim 19, wherein the information provided by the curriculum manager representative of each of the current CE activities further includes, for each CE activity, at least one of: a status of the CE activity and the user's completion thereof, a number of credit hours for the CE activity, date of last access of the CE activity by the user, and an indication of whether the CE activity has been submitted for credit.

23. The method of claim 19, wherein the step of providing in the curriculum manager further includes at least one of adding and removing at least one CE activity in the user's curriculum.

24. The method of claim 19, wherein the step of providing in the curriculum manager includes launching one or more CE activities in the user's curriculum.

25. The method of claim 19, wherein the catalog browser search engine includes a search locating activities based on single, user-defined categories available within the catalog.

26. The method of claim 19, wherein the catalog browser search engine includes a search wizard searching by one or more of: profession, topic, product category, condition, disease, disorder, keyword, and phrase.

27. The method of claim 19, wherein the catalog browser search engine further includes a display screen having information about the located at least one CE activity, the information including one or more of: brief description, the number of credit hours, professional accreditation, prior user ratings; a first means for adding an activity to the user's curriculum; and a second means for launching a selected one of the CE activities and adding the selected one of the CE activities to the user's curriculum.

28. The method of claim 19, wherein the step of tracking, in the personal transcript manager, further includes tracking online CE activities and offline CE activities.

29. The method of claim 28, wherein the step of tracking includes tracking the offline CE activities by allowing transcript data to be entered for the offline CE activities; and tracking the online CE activities by accessing online CE information to automatically update transcript data.

30. The method of claim 19, wherein the step of tracking, in the personal transcript manager, further includes displaying CE activities completed by the user in relation to at least one of jurisdiction and period of licensure.

31. The method of claim 19, wherein the step of tracking, in the personal transcript manager, includes reprinting a certificate for CE earned by the user; and at least one of generating and customizing at least one of the transcripts and a report showing at least one of accredited CE activities, non-accredited CE activities, and completed CE activities, in the user's transcript.

32. The method of claim 19, further comprising the step of managing the user's account, in an account manager, including allowing a user to at least one of view and change account information in the user's account, including modifying contact information, personal information, one or more jurisdictions of licensure, and profession.

33. The method of claim 19, further comprising the step of showcasing information, in a showcase system, displaying information concerning at least one of selected CE activities and selected libraries in the interactive CE system, including shortcuts to locate the selected CE activities and the selected libraries; adding one of the selected CE activities to the user's curriculum; and launching the one of the selected CE activities.

34. The method of claim 19, further comprising the step of managing, responsive to user request, a user's preferences in a preference manager, and determining to alert the user if at least one activity of interest is added to the catalog.

35. The method of claim 34, wherein the step of managing, in the preference manager further includes at least one of creating and editing a set of user preferences including at least one user preference, and notifying the user of one or more CE activities added to the catalog and which match the at least one user preference.

36. A computer-based method for managing and/or providing continuing healthcare education (CE) activities, in an interactive CE method for users including physicians and healthcare providers, implemented by a computer system, said interactive CE method comprising the steps of:
(A) providing, in a personal profile, data indicative of at least one CE activity in a user's curriculum and adding or more CE activities to the user's curriculum, including listing one or more CE activities open in the user's curriculum; providing information representative of a user's educational progress characterized by the open CE activities in the user's curriculum against a time remaining in a licensure period for one or more jurisdictions indicated by the user; providing information about CE requirements for one or more specified jurisdictions; providing information about the open one or more CE activities open in the user's curriculum and a status of the user's progress in the CE activities; and configuring the licensure period for one or more jurisdictions indicated by the user;
(B) providing, in a curriculum manager, information representative of the open one or more CE activities, including status, number of credit hours, a date of last access by the user, an indication of whether the CE activities have been submitted for credit; at least one of adding and removing one or more CE activities in the user's curriculum; and launching one or more CE activities in the user's curriculum;
(C) searching, responsive to a user request, via a catalog browser search engine, a catalog of a plurality of CE activities to locate activities of interest to the user, including at least one of: locating CE activities in the catalog based on a single, user-defined categories available within the catalog; and searching for CE activities in the catalog by one or more of: profession, topic, product category, condition, disease, disorder, keyword, and phrase; providing a display screen having information for each located CE activity including one or more of: brief description, a number of credit hours, professional accreditation, and prior user ratings; adding a selected one of the located CE activities to the user's curriculum; and launching a selected one of the located CE activities and adding the selected one of the located CE activities to the user's curriculum;
(D) tracking, via a personal transcript manager tracking, in a transcript for the user, at least one of completed online CE activities and offline CE activities, including allowing the user to enter a transcript data for the offline CE activities, accessing online CE information to automatically update the user's transcript; displaying completed CE activities in the user's transcript in relation to at least one of jurisdiction and period of licensure; reprinting certificates for CE activities earned by the user; and at least one of generating and customizing at least one of the transcripts and a report showing at least one of accredited CE activities, non-accredited CE activities, and completed CE activities, in the user's transcript;
(E) managing the user's account, in an account manager, including allowing a user to at least one of view and change account information in the user's account, including modifying contact information, personal information, one or more jurisdictions of licensure, and profession;
(F) showcasing information, in a showcase system, by displaying information concerning at least one of selected CE activities and selected libraries in the interactive CE system, including shortcuts to locate the selected CE activities and the selected libraries; adding one of the selected CE activities to the user's curriculum; and launching the one of the selected CE activities; and
(G) managing, responsive to user request, a user's preferences via a preference manager, and reviewing at least one user preference and determining when to alert the user as at least one CE activity of interest is added to the catalog; including at least one of creating and editing a set of one or more user preferences including at least one user preference, and notifying the user of one or more CE activities added to the catalog and which match the at least one user preference.

37. In a computer-based system for managing and/or providing continuing healthcare education (CE) activities, an interactive CE system for users including physicians and healthcare providers, implemented by a computer system, said interactive CE system comprising:
(A) a personal profile means for providing information representative of a user's educational progress characterized by one or more CE activities in a curriculum of the user, against licensure requirements for one or more jurisdictions selected by the user;
(B) a curriculum manager means for providing information representative of the current CE activities in the curriculum of the user;
(C) a catalog browser search engine means for searching a catalog of CE activities to locate CE activities of interest for the user; and
(D) a personal transcript manager means for tracking completed online CE activities of the user in a transcript for the user.

38. The system of claim 37, wherein the information representative of the user's educational progress is further characterized by a time remaining in a licensure period for the selected one or more jurisdictions.

39. The system of claim 37, wherein the personal profile means further includes at least one of: providing data indicative of at least one CE activity in the user's curriculum; adding at least one CE activity to the user's curriculum; listing one or more CE activities that are open in the user's curriculum; providing information about CE requirements for one or more specified jurisdictions; providing information about the one or more open CE activities and a status of the user's progress in the open CE activities; and configuring the one or more licensure periods for the user for at least one of the jurisdictions.

40. The system of claim 37, wherein the information provided by the curriculum manager means representative of each of the current CE activities further includes, for each CE activity, at least one of: a status of the CE activity and the user's completion thereof, a number of credit hours for the CE activity, date of last access of the CE activity by the user, and an indication of whether the CE activity has been submitted for credit.

41. The system of claim 37, wherein the curriculum manager means further at least one of means for adding and removing at least one CE activity in the user's curriculum.

42. The system of claim 37, wherein the curriculum manager means launches one or more CE activities in the user's curriculum.

43. The system of claim 37, wherein the catalog browser search engine means includes a search means for locating activities based on single, user-defined categories available within the catalog.

44. The system of claim 37, wherein the catalog browser search engine means includes a search wizard means for searching by one or more of: profession, topic, product category, condition, disease, disorder, keyword, and phrase.

45. The system of claim 37, wherein the catalog browser search engine means further includes a display screen having information about the located at least one CE activity, the information including one or more of: brief description, the number of credit hours, professional accreditation, prior user ratings; a first means for adding an activity to the user's curriculum; and a second means for launching a selected one of the CE activities and adding the selected one of the CE activities to the user's curriculum.

46. The system of claim 37, wherein the personal transcript manager means further tracks online CE activities and offline CE activities.

47. The system of claim 46, wherein the offline CE activities are tracked by allowing transcript data to be entered for the offline CE activities; and wherein the online CE activities are tracked by accessing online CE information to automatically update transcript data.

48. The system of claim 37, wherein the personal transcript manager means further displays CE activities completed by the user in relation to at least one of jurisdiction and period of licensure.

49. The system of claim 37, wherein the personal transcript manager means reprints a certificate for CE earned by the user; and at least one of generates and customizes at least one of the transcripts and a report showing at least one of accredited CE activities, non-accredited CE activities, and completed CE activities, in the user's transcript.

50. The system of claim 37, further comprising an account manager means for allowing a user to at least one of view and change account information in the user's account, including modifying contact information, personal information, one or more jurisdictions of licensure, and profession.

51. The system of claim 37, further comprising a showcase means for displaying information concerning at least one of selected CE activities and selected libraries in the interactive CE system, including shortcuts to locate the selected CE activities and the selected libraries; means for adding one of the selected CE activities to the user's curriculum; and means for launching the one of the selected CE activities.

52. The system of claim 37, further comprising a preference manager means, for determining to alert the user if at least one activity of interest is added to the catalog.

53. The system of claim 52, wherein the preference manager means further includes at least one of creating and editing a set of user preferences including at least one user preference, and means for notifying the user of one or more CE activities added to the catalog and which match the at least one user preference.

54. In a computer-based system for managing and/or providing continuing healthcare education (CE) activities, an interactive CE system for users including physicians and healthcare providers, implemented by a computer system, said interactive CE system comprising:
(A) a personal profile means for providing data indicative of at least one CE activity in a user's curriculum and adding one or more CE activities to the user's curriculum, including means for listing one or more CE activities open in the user's curriculum; means for providing information representative of a user's educational progress characterized by the open CE activities in the user's curriculum against a time remaining in a licensure period for one or more jurisdictions indicated by the user; means for providing information about CE requirements for one or more specified jurisdictions; means for providing information about the open one or more CE activities open in the user's curriculum and a status of the user's progress in the CE activities; and means for configuring the licensure period for one or more jurisdictions indicated by the user;
(B) a curriculum manager means for providing information representative of the open one or more CE activities, including status, number of credit hours, a date of last access by the user, an indication of whether the CE activities have been submitted for credit; means for at least one of adding and removing one or more CE activities in the user's curriculum; and means for launching one or more CE activities in the user's curriculum;
(C) a catalog browser search engine means for searching a catalog of a plurality of CE activities to locate activities of interest to the user, including at least one of: means for locating CE activities in the catalog based on a single, user-defined categories available within the catalog; and means for searching for CE activities in the catalog by one or more of: profession, topic, product category, condition, disease, disorder, keyword, and phrase; a display screen having information for each located CE activity including one or more of: brief description, a number of credit hours, professional accreditation, and prior user ratings; a first means for adding a selected one of the located CE activities to the user's curriculum; and a second means for launching a selected one of the located CE activities and adding the selected one of the located CE activities to the user's curriculum;
(D) a personal transcript manager means for tracking, in a transcript for the user, at least one of completed online CE activities and offline CE activities, including means for allowing the user to enter a transcript data for the offline CE activities; means for accessing online CE information to automatically update the user's transcript; means for displaying completed CE activities in the user's transcript in relation to at least one of jurisdiction and period of licensure; means for reprinting certificates for CE activities earned by the user; and means for at least one of generating and customizing at least one of the transcripts and a report showing at least one of accredited CE activities, non-accredited CE activities, and completed CE activities, in the user's transcript;
(E) an account manager means for allowing a user to at least one of view and change account information in the user's account, including modifying contact information, personal information, one or more jurisdictions of licensure, and profession;
(F) a showcase means for displaying information concerning at least one of selected CE activities and selected libraries in the interactive CE system, including shortcuts to locate the selected CE activities and the selected libraries; means for adding one of the selected CE activities to the user's curriculum; and means for launching the one of the selected CE activities; and
(G) a preference manager means for reviewing at least one user preference and determining when to alert the user as at least one CE activity of interest is added to the catalog, including means for at least one of creating and editing a set of one or more user preferences including at least one user preference, and means for notifying the user of one or more CE activities added to the catalog and which match the at least one user preference.
